(19) United States
(12) Patent Application Publication
(10) Pub. No.: US 2006/0004725 A1
(43) Pub. Date: Jan. 5, 2006

(54) Automatic generation of a search engine for a structured document

(76) Inventor: Leonor Maria Abraido-Fandino, Franklin Square, NY (US)

Correspondence Address: DLA PIPER RUDNICK GRAY CARY US, LLP, 2000 UNIVERSITY AVENUE, E. PALO ALTO, CA, 94303-2248, US

(21) Appl. No.: 11/143,819

(22) Filed: Jun. 2, 2005

Related U.S. Application Data
(60) Provisional application No. 60/578,439, filed on Jun. 8, 2004.

(51) Int. Cl. G06F 17/30

(52) U.S. Cl. 707/3

(57) ABSTRACT

We describe a search engine generator that automates the process of creating a search engine for a particular structured document written in a natural language such as English. The search engine allows more convenient and flexible analysis of information stored in natural language documents than is currently available with World Wide Web search engines or portal builders. Specifically, it displays matching records in a tabular format for easy comparison; this may include information calculated with data from the document. Further, the search engine's graphical user interface (GUI) is available in different natural languages to facilitate searches by international users, and the GUI has a customizable graphic design.

This application claims the benefit of U.S. Provisional Application No. 60/578,439, filed on Jun. 8, 2004.

### BACKGROUND OF THE INVENTION

1. Field of the Invention

This invention is in the area of computer software systems. Specifically, it involves natural language processing to extract a document's structured information, or records. The records are used to automatically create a relational database for which a search engine is generated. The search engine has a graphical user interface.

2. Description of Prior Art

Most human knowledge is still in the form of books or other documents written in a natural language such as English. Many such texts contain structured data; the plant catalog typically found in the reference section of a gardening book is an example. Unfortunately, the tools available for analysis of natural language texts are primitive by comparison to those for analysis of information in relational databases, even when the text is available in an electronic format.

Word processors, such as Microsoft Word, have a Find command for searching documents, but it limits users to looking for particular words or phrases. World Wide Web search engines, such as Google, have more flexible query capabilities, allowing users to find Web pages that contain all of the given words and phrases, regardless of the order in which they appear on the page. With such search engines it is even possible to look for pages that do not contain a certain word or phrase, or that contain any of the given words or phrases. However, the result of a Web search is a list of links to the pages containing the desired information. Thus, if the user wants to summarize the information in one document, he must manually examine each link and copy the desired information to a new document.

For instance, suppose a gardening store has written a reference manual that lists various plants, their flower color, blooming period, and care instructions. The gardening store makes this manual available on its Web site so that its shoppers can make well-informed purchasing decisions. If gardeners search the Web to find plants with white flowers that bloom in spring, pages from the gardening store's reference manual will no doubt appear in the search results, along with many other irrelevant pages that contain the same search words and phrases. The plants' names and care instructions—what the gardeners really want as the result of their search—will be buried within the links. The gardeners may need to examine many irrelevant links before finding those for the gardening store's reference manual. Once found, they may want to consolidate the plants' names and care instructions in one document so they can check which plants will do well in their geographic area, and determine if they have the time required to care for them properly. To do this consolidation, though, the gardeners must click each relevant link, then copy and paste the information into their document. This process can be quite labor-intensive, even if the search was done right on the gardening store's Web site, so that the search results contain only the reference manual's pages. For structured documents such as this gardening reference manual, it would be far more useful to provide a flexible search capability that displays the results in a single table.

To provide such a flexible search capability, the gardening store could hire a software engineer to design and implement a relational or XML database containing the reference manual's information. The software engineer would also need to design and implement a graphical user interface that would allow gardeners to search the database, displaying the results in a report. Typically, a graphic designer would have to be hired to provide the artwork used within the graphical user interface. Further, the gardening store might have to hire a data entry clerk to copy the information from the reference manual to the database; this process may introduce errors, lowering the quality of the finished product. Overall, this is an expensive, time-consuming undertaking for the gardening store.

Quality can be improved, and costs lowered, by automating the process of going from a structured document written in a natural language to a search engine for that document.

### BRIEF SUMMARY OF THE INVENTION

We describe a software system that automatically generates a search engine for a particular structured document, displaying the results in a report. Search Engine Generator reads the source document, written in a natural language such as English, to extract its structured data, or records. It automatically creates a database containing these records, and a search engine that can be used to search and display the data in the database.

The search engine's graphical user interface is internationalized and localized, with a user-specified graphic design. It allows searching by primary key or by any combination of columns, and the user may sort the results by any column. The graphical user interface allows setting preferences that control the display of search results. It provides an index of primary key values, online help, and legal notices. The search engine's server component uses database connection pooling to minimize the time required for database access.

The automatically generated search engine can be created to run (1) within the World Wide Web via a browser and Web server; (2) within a network of computers; (3) as a standalone system on one computer; or (4) as a personal digital assistant application. When regenerating the search engine to run on a different target platform, components are reused if possible. This reduces the time to create the new version of the search engine, and ensures consistency among the various versions of the search engine for a given document.

### BRIEF DESCRIPTION OF THE SEVERAL VIEWS OF THE DRAWING

We include a list of all figures by number and describe what each figure illustrates.

FIG. 1 Search Engine Generator's runtime environment

FIG. 2 Search Engine Generator's inputs, outputs, and main components

FIG. 3 Data Extractor's inputs, outputs, and main components

FIG. 4 Database Generator's inputs, outputs, and main components

FIG. 5 GUI Generator's inputs, outputs, and main components

FIG. 6 Search Engine Installer's inputs, outputs, and main components

FIG. 7 Search Engine's inputs, outputs, and main components

FIG. 8 Administrator's inputs, outputs, and main components

FIG. 9 Example of a legal notice displayed within Search Engine Generator

FIG. 10 Part of Search Engine Generator's online help for Extractor Configuration

FIG. 11 File Chooser dialog box

FIG. 12 Wizard form for Record Specification's data

FIG. 13 Top half of the wizard form for Extractor Configuration's data

FIG. 14 Bottom half of the wizard form for Extractor Configuration's data

FIG. 15 Wizard form for Database Configuration's data

FIG. 16 Wizard form for Part 1 of GUI Configuration's data

FIG. 17 1^{st} quarter of the wizard form for Part 2 of GUI Configuration's data

FIG. 18 2^{nd} quarter of the wizard form for Part 2 of GUI Configuration's data

FIG. 19 3^{rd} quarter of the wizard form for Part 2 of GUI Configuration's data

FIG. 20 4^{th} quarter of the wizard form for Part 2 of GUI Configuration's data

FIG. 21 Top half of the wizard form for Part 1 of Installer Configuration's data

FIG. 22 Bottom half of the wizard form for Part 1 of Installer Configuration's data

FIG. 23 Wizard form for Part 2 of Installer Configuration's data

FIG. 24 Home page for a sample Web-based search engine

FIG. 25 Advanced Search page for a sample Web-based search engine

FIG. 26 Index page for a sample Web-based search engine

FIG. 27 Full Text Search page for a sample Web-based search engine

FIG. 28 Source document for a sample Web-based search engine

FIG. 29 Search results from a sample Web-based search engine

FIG. 30 Error from a search with a sample Web-based search engine

FIG. 31 Top half of preferences page for a sample Web-based search engine

FIG. 32 Bottom half of preferences page for a sample Web-based search engine

FIG. 33 Part of the help page for a sample Web-based search engine

FIG. 34 Legal notice for a sample Web-based search engine

FIG. 35 Wizard form for Administrator Configuration's data

FIG. 36 User-supplied data in the help page of a sample Web-based search engine

### DETAILED DESCRIPTION OF THE INVENTION

We could architect Search Engine Generator in a variety of ways, and use several programming languages or software systems to implement it. However, the preferred embodiment of Search Engine Generator is as a wizard running as a World Wide Web application. Its graphical user interface (GUI) guides the user through the various steps of the search engine generation and installation process, automatically creating the necessary configuration files and ensuring consistency between steps.

FIG. 1 shows Search Engine Generator's runtime environment in the preferred embodiment. Its GUI is a wizard that runs within a standard Web browser such as Netscape Communications Corporation's Netscape or Microsoft Corporation's Internet Explorer. Search Engine Generator also has a servlet component that runs on a Web server such as Apache Software Foundation's Tomcat or BEA Systems, Inc.'s WebLogic. The GUI and servlet communicate via standard HyperText Transfer Protocol (HTTP) between the Web browser and server.

The servlet creates and communicates with a relational database containing the information that will be used for searches. This database may reside on a separate database server, as shown in FIG. 1, but this is not necessary in order for Search Engine Generator to function correctly. The database may be implemented with any relational database management system (RDBMS); examples are Oracle Corporation's Oracle9 and Microsoft Corporation's Access. The servlet and database communicate with standard Java Database Connectivity (JDBC) methods.

In the preferred embodiment, we use Sun Microsystems' Java programming language and JavaServer Pages (JSP), the World Wide Web Consortium's Extensible Markup Language (XML) and HyperText Markup Language (HTML), a relational database management system (RDBMS), and document editors such as word processors.

We use Java for the servlet and its server components, including those that are part of the automatically generated search engine. Their input files are written in XML, as are any intermediate files that the servlet or server components create. We use XML to facilitate data transfer, where each type of XML file is specified with its own XML schema language. By using XML Stylesheet Language for Transformations (XSLT) with XML Stylesheet Language (XSL) to do the final transformation to the target platform, we avoid having to regenerate the output files whenever a different format is requested.

Search Engine Generator's GUI is written in HTML or JSP and these files may reference images or cascading style sheets; the GUI may contain code written in Netscape Communications Corporation's JavaScript, Microsoft Corporation's JScript, or ECMA's ECMAScript. Search Engine Generator's GUI, including online help, is internationalized and localized using Java's internationalization and localization features.

For Web-based versions of the automatically generated search engine, Search Engine Generator creates its GUI in HTML or JSP using XSLT and XSL to transform the corresponding XML. The resulting HTML or JSP may reference images or cascading style sheets, and may contain code written in JavaScript, JScript, or ECMAScript. For other versions of the search engine, Search Engine Generator provides a library for the search engine to use at initialization. The library uses Java Swing for network and standalone search engines, or Java 2 Micro Edition (J2ME) for search engines running on personal digital assistants (PDAs); these Java tools provide the target platform's native “look and feel” for the graphical user interface. With methods from this library, the search engine reads the XML files containing its GUI elements, and populates its GUI with the necessary labels, text fields, buttons, and other components. The search engine's GUI is internationalized and localized with Java's standard features for doing so.

The RDBMS stores the data on which searches are based, providing persistence between sessions; it also provides search capabilities. The search engine launches a document editor when the user wants to browse or search the source document.

We describe the invention in two parts. We start with an overview of the search engine generation process, explaining Search Engine Generator's overall architecture and the general structure of each of its main components. We finish by detailing how each main component is used and engineered; this includes an explanation of the automatically generated search engine's features and architecture. We use the following acronyms in the discussion.
API application programming interface
ASCII American Standard Code for Information Interchange
CSS cascading style sheet
DSN Data source name
ECMA European computer standards group responsible for ECMAScript
ISO International Standards Organization
J2ME Java 2 Micro Edition
JDBC Java Database Connectivity
JPEG Joint Photographic Experts Group
JSP JavaServer Pages
GIF Graphics Interchange Format
GUI graphical user interface
HTML HyperText Markup Language
HTTP HyperText Transfer Protocol
OCR optical character recognition
PDA personal digital assistant
RDBMS relational database management system
SAX Simple API for XML
SQL Structured Query Language
UTF Unicode Transformation Format
XML Extensible Markup Language
XSL XML Stylesheet Language
XSLT XML Stylesheet Language for Transformations

### Overview of the Search Engine Generation Process

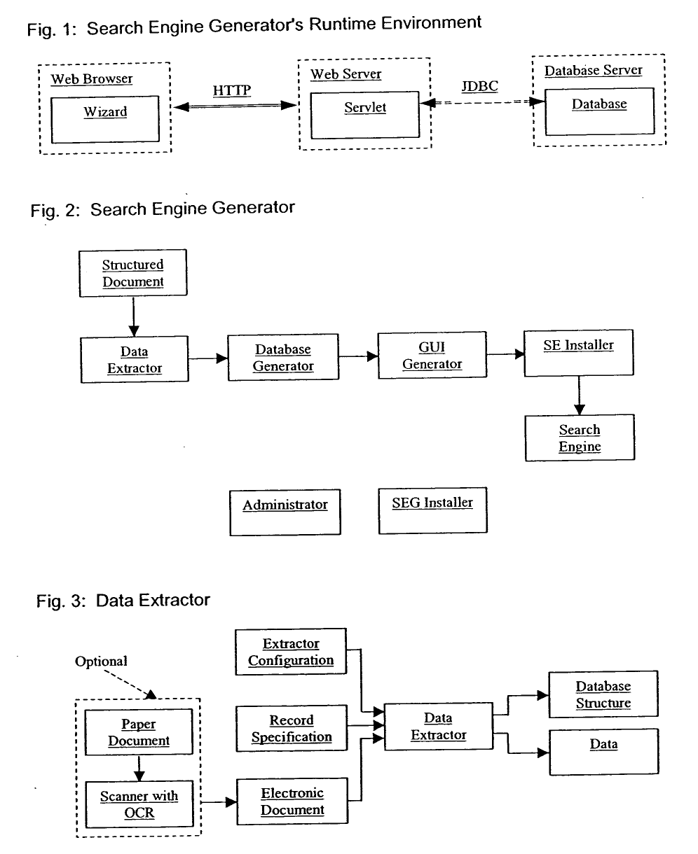

FIG. 2 shows the overall structure of Search Engine Generator, including its inputs and outputs. Search Engine Generator has four main steps; each step is processed by a corresponding component, which is implemented as a Java class. The source document, labeled Structured Document in FIG. 2, is first processed by the Data Extractor component, which extracts the list of records in the document. These records are then fed to Database Generator, the component that automatically creates the database. Afterwards, GUI Generator creates the search engine's graphical user interface. Finally, the SE Installer combines the graphical user interface with predefined libraries to generate Search Engine, a search engine running on the target platform. The Administrator component is used for maintenance tasks, such as regenerating the search engine's online help after the user supplies examples. The SEG Installer is used to install Search Engine Generator itself.

For each step of the search engine generation process, Search Engine Generator's GUI presents the user with a form to fill out. This form specifies the parameters that control the corresponding component's actions, as detailed below. The GUI provides a list of choices and default values whenever possible. It also copies values from prior steps' forms to ensure consistency throughout the search engine generation process.

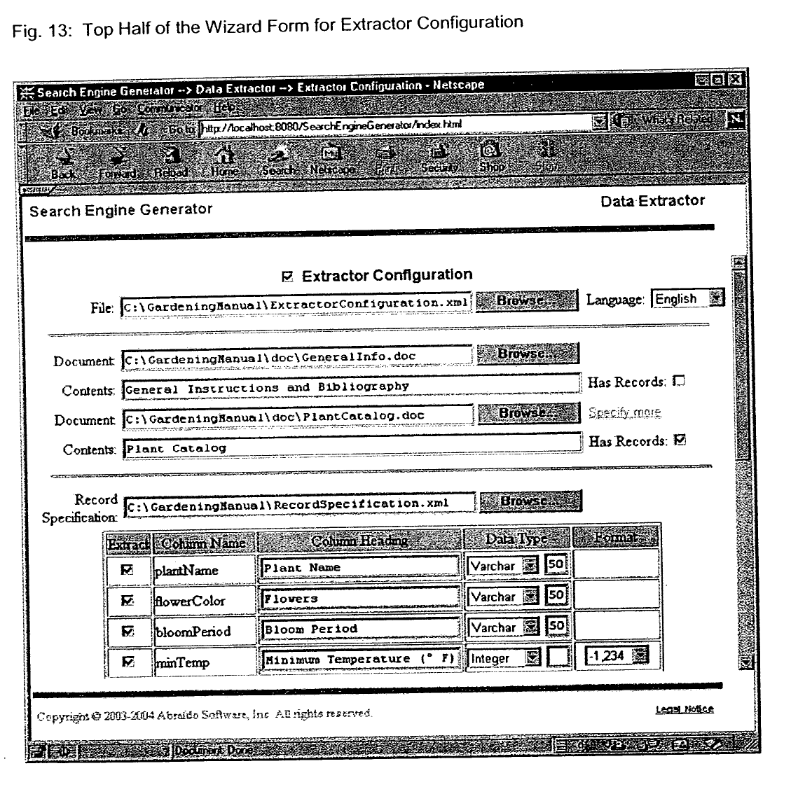

All such forms contain a title that describes the step of the search engine generation process to which it corresponds. For example, FIG. 13 shows the form for specifying the parameters that control data extraction. This is part of Search Engine Generator's Data Extractor step. FIG. 13 also illustrates the copyright notice displayed in each wizard form, and the Legal Notice link that displays legal notices associated with the application. A sample legal notice is shown in FIG. 9; it is meant as an example, and does not necessarily cover all the legal issues that are addressed in Search Engine Generator's actual legal notice. Similarly, FIGS. 9-10, 12, and 14-23 show the titles, copyright notices, and Legal Notice links of the other wizard forms.

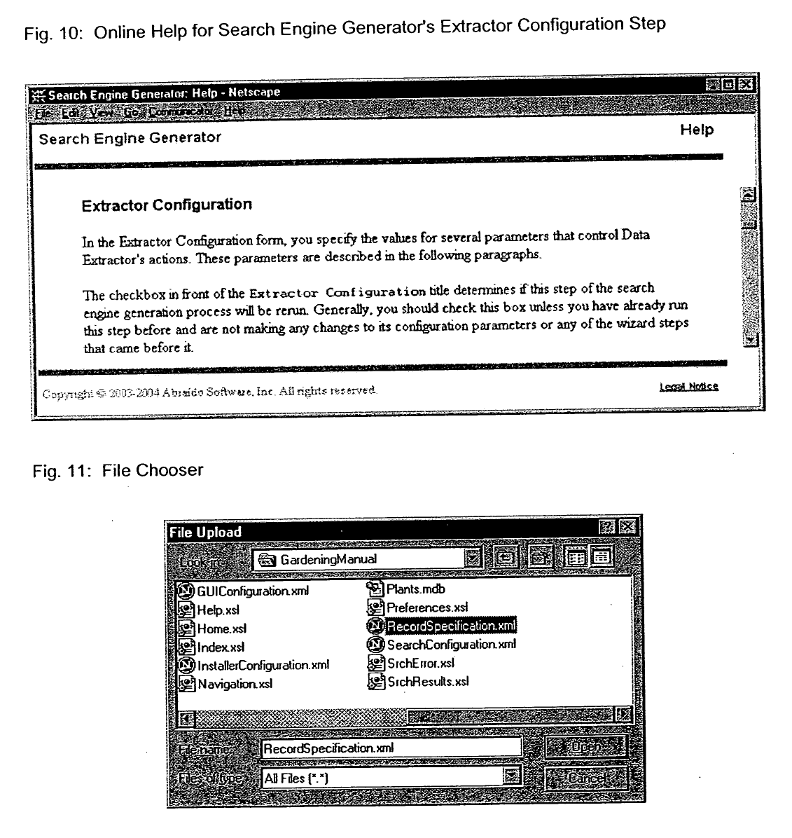

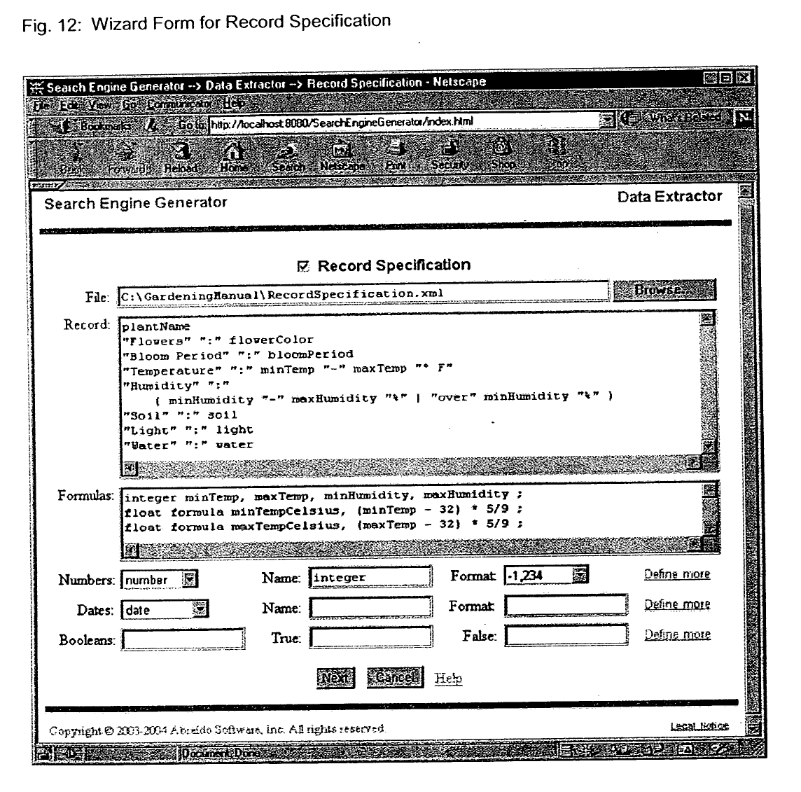

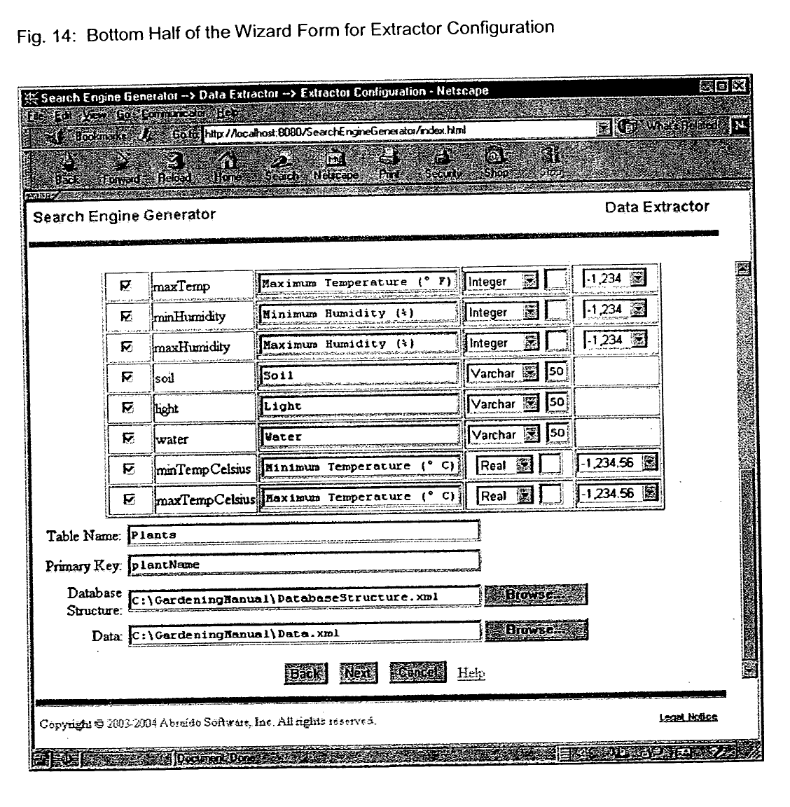

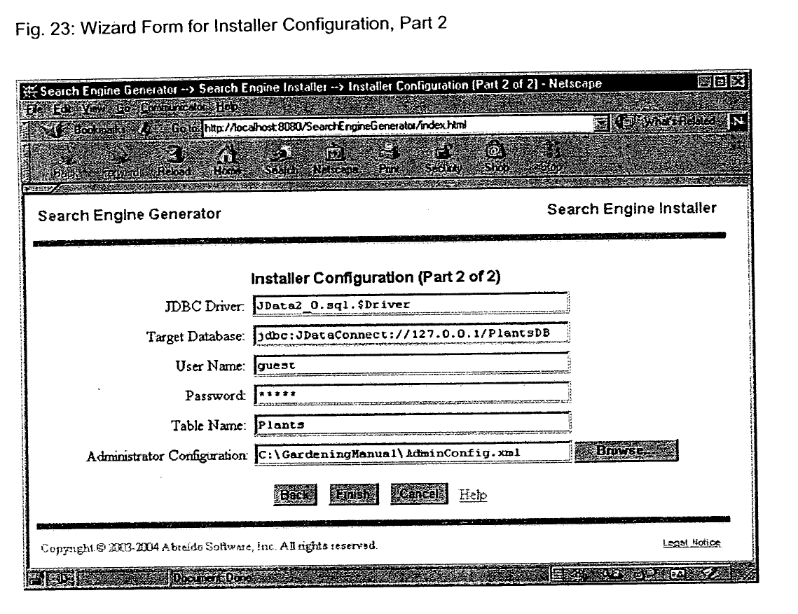

All GUI forms have the standard buttons found in wizards. For example, the form for step one has a Next button to proceed to the next step. The forms for intermediate steps have Back and Next buttons to go to the prior or next step. The last step's form has Back and Finish buttons; the Finish button actually generates the search engine. All the forms also have a Cancel button to terminate Search Engine Generator without creating any search engine, and a Help link for displaying instructions for filling out the form. FIG. 14 shows the Back, Next, and Cancel buttons along with the Help link. FIG. 23 shows the Finish button, while FIG. 10 shows part of the online help for the Extractor Configuration form. Similarly, FIGS. 12, 15-16, 20, and 22-23 show the applicable Back, Next, and Cancel buttons along with the Help link of the other wizard forms. Note that the Help link displays the instructions associated with the particular form on which it is clicked; for example, clicking Help on the Record Specification form of FIG. 12 would display instructions for specifying the source document's records. The instructions always appear in a separate window to avoid obscuring the form that is being filled.

For a given structured document, Search Engine Generator can be used to create search engines that run on different target platforms. All such search engines operate on the same source data, that from the structured document. So the data extraction step needs to be executed only once, regardless of how many search engines must be created. Similarly, several target platforms may be able to use the same database, implying that database generation may need to occur only once. The same applies to GUI generation. Installation parameters will typically change for different target platforms, but some parameters' values may be the same. Thus, each form in the Search Engine Generator wizard has a Browse button that allows the user to find the configuration file that resulted from that step in a prior run of the wizard; FIG. 13 shows such a Browse button next to the File text field that stores the configuration file's name. Similarly, FIGS. 12, 15-16, and 21 show the File text field and Browse button for the other wizard forms. The parameter values from the configuration file, written in XML, will be used to populate the form's fields. The user can then proceed to the next step, if the results can be used as is, or make any required changes to the parameters. Changes can be saved in the old file, overwriting the prior values, or in a new file.

The wizard's forms contain other Browse buttons. They're used wherever a file name must be entered in the wizard, as illustrated in FIGS. 13-16 and 19-23. If the user clicks a Browse button, the browser displays a standard file chooser dialog box so the user can select the desired file. FIG. 11 contains an example of such a file chooser. The Look in field shows the current directory, which is GardeningManual in this example. Clicking the drop-down list's arrow will display a tree-like data structure containing the network's computers as well as the computers' disks, directories, and subdirectories. The display will show the full path to the current directory. Clicking within the tree will change the current directory being browsed. With the buttons next to the drop-down list containing the current directory, it is possible to move up one level in the tree, create a new folder in the current directory, or change the display format in the dialog box's main area. The display format can either be a list, or a list containing details such as the files' size, their type, last modification time, and attributes.

The main area of the dialog box displays the files within the current directory. Since the Files of type field is set to All Files (*.*), all of the directory's files are displayed. Setting this field to another value causes the main area to display only the files of the indicated type; for instance, if this field were set to HTML Files, then only the directory's HTML files would be displayed.

In FIG. 11, the user has selected the RecordSpecification.xml file in the dialog box's main area, and its name was automatically copied to the File name field. When the user clicks the Open button, the file's full path name will be copied to the input box associated with the Browse button within the Search Engine Generator wizard. The dialog box's Cancel button dismisses the dialog box without making any changes within the wizard.

Each form in the wizard also has a checkbox where the user indicates if the corresponding search engine generation step must be rerun, or if it can be skipped because its results from a prior run can be used again. This checkbox appears next to the form's title; an example is shown in FIG. 13. Since the box is checked, it means that the Extractor Configuration step will be rerun. Similarly, FIGS. 12, 15-16, and 21 indicate that those wizard steps will also be rerun because the checkbox next to each form's title is checked.

Whenever the user clicks a button on a form, the browser uses HTTP to send the value in each of the form's fields to the Search Engine Generator servlet; it also sends the value of a hidden field containing the form's identification code. The servlet's actions depend on which button was clicked.

If the user clicks the Cancel button, Search Engine Generator exits without creating any search engine.

Once the XML file is selected with the Browse button next to the form's File field, the button's on Change event handler is called. The associated JavaScript function calls the Search Engine Generator servlet. It creates an instance, if it doesn't already exist, of the Java class that implements this search engine generation step; the servlet determines the class based on the form's identification code. The servlet invokes the instance's SAX parser to read the configuration file. The servlet then invokes standard get methods on the instance to retrieve the value of each of these configuration parameters, and uses these values to populate the GUI form. The servlet then displays the filled-in form. The user is free to change any field's value. If he wants to create a new configuration file with the edited values, he enters the new file's name in the designated field on the form without using its Browse button, which would possibly overwrite his changes. Otherwise, the edited values replace those in the existing configuration file.

If the user clicks the Next button on a form, the Search Engine Generator servlet uses the values in the form to initialize or update the Java class whose configuration parameters have just been entered. The servlet keeps track of whether or not this step must be rerun, as specified by the user on its form. The servlet then displays the next step's form, filling in any values that depend on the prior steps' parameters.

If the user clicks the Back button on a form, the servlet populates the prior step's form with the data in the instance of the Java class that models the prior step. It then displays the filled-in form for the prior step.

When the user clicks the Finish button, the servlet begins the search engine generation process. For each step in the process, it invokes the corresponding component. This component first writes its configuration parameters to an XML file named as the user indicated with the wizard. For compatibility between Search Engine Generator versions, the component writes into the file the version of the XML schema language in which the configuration file is written. Writing the configuration file is skipped if the user had specified that this search engine generation step can be skipped, as noted in Paragraph [0028]. Next, the component executes its search engine generation task, provided this step needs to be rerun. The servlet then repeats this process for each remaining step in the search engine generation process.

The XML file parsers used within the wizard and servlet are stored in instance variables that are part of the Java classes that implement each step in the search engine generation process. These parsers read the version number stored at the beginning of the file to determine which version of the parsing algorithm to use on the file. If the version number is newer than that of the currently running parser, then the file can't be parsed with the currently executing Search Engine Generator and the user is given a message to that effect. Otherwise, the parser creates and invokes an instance of the SAX parser that knows how to parse the XML file.

In the preferred embodiment, each SAX parser is modeled with a class that extends org.xml.sax.helpers.DefaultHandler. Whenever a Search Engine Generator developer changes an XML schema language, he saves its existing SAX parser by copying and renaming its Java class. He then modifies the existing SAX parser as needed so that it can parse files written in the new version of the XML schema language. He modifies the code that determines which SAX parser to use by updating the name of the renamed Java class, and adding a test for the current version of the XML schema language. This approach avoids cluttering the SAX parser's code with tests for the version number and actions based on its value, so the SAX parser's logic should be easier to follow.

For example, assume that versionNum is the version number retrieved from the XML file, ParserHandler is the class that extends org.xml.sax.helpers.DefaultHandler, Parser_{—}1_{—}0 is the Java class that extends ParserHandler to parse version 1.0 of the XML schema language, Parser_{—}2_{—}0 is the Java class that extends ParserHandler to parse version 2.0 of the XML schema language, and Parser is the Java class that extends ParserHandler to parse the current version of the XML schema language, which is 3.0. Also assume that fileName contains the full path name of the XML file that needs parsing. The following Java code fragment demonstrates how the version number can be used to select and invoke the right SAX parser.

import java.io.File;
import javax.xml.parsers.SAXParserFactory;
import javax.xml.parsers.SAXParser;
// Code to define the parser and its methods goes here. The
// following code fragment is part of the method that actually
// parses the XML file.
ParserHandler handler = null;
if (versionNum.equals(“1.0”)) {
handler = new Parser_1_0( );
}
else if (versionNum.equals(“2.0”)) {
handler = new Parser_2_0( );
}
else if (versionNum.equals(“3.0”)) {
handler = new Parser( );
}
else {
// Code to issue an error message: unknown version number
}
SAXParserFactory parserFactory = SAXParserFactory.newInstance( );
try {
SAXParser theParser = parserFactory.newSAXParser( );
theParser.parse(new File(fileName), handler);
}
catch (Throwable problem) {
// Code to handle exceptions.
}
// Rest of the parser's code goes here.

The SAX parsers for XML files have a standard design and implementation. Their startDocument method creates an instance of the Java class that models the step's configuration parameters, assigning it to an instance variable within the parser. When the SAX parser encounters the start of a new XML element, its startElement method is called; it creates an instance of the Java class that models the corresponding parameter, assigning it to another instance variable within the parser. Once the SAX parser encounters the parameter's actual data value, its characters method copies the value from the configuration file to the Java object representing the parameter. The SAX parser's endElement method is called when the parser reads the end of the XML element. This method adds the Java object representing the parameter to the list of parameters stored in the Java object that represents all the step's configuration parameters. Once the SAX parser sees the end of the configuration file, its endDocument method merely frees any objects that are no longer needed, since the object representing all the configuration parameters is fully initialized already.

Each Search Engine Generator component, including the wizard and servlet, also uses a resource bundle. This is an XML file that stores bundle names along with their key/value pairs; it also has an element to store the version of the XML schema language used within the file. Each component reads its own resource bundle with a standard SAX parser that creates standard Java ResourceBundle objects; these objects allow the component to provide internationalized and localized messages. Since resource bundles are a Java standard, we don't mention them any further except in the case of GUI Generator, where we explain how it uses a resource bundle to create an internationalized and localized GUI for the automatically generated search engine.

Search Engine Generator uses standard session tracking to keep track of the set of Java objects that belong to each user's search engine generation process.

Search Engine Generator is installed with a wizard that guides the user through the installation process. This installer wizard is designed and implemented in a standard way. In fact, the preferred embodiment uses a third-party installation development tool, such as InstallShield's MultiPlatform, to create this installer. Besides the usual welcome and licensing agreement screens, Search Engine Generator Installer presents the user with two forms to fill out. The first form asks the user to select the target Web server from a list of supported Web servers. It also asks the user to select the directory where Search Engine Generator should be installed. In the second form, Search Engine Generator Installer determines where to install Search Engine Generator's GUI files and server. These directories typically depend on the target Web server, but the user may change the values the installer provides. Once the user tells the installer to proceed with installation, the installer copies the Search Engine Generator files from the distribution media, such as a compact disk, to the destination directories specified in the second form of the wizard. If needed, it also updates the Web server's configuration files with Search Engine Generator's application name and other required Web server parameters.

The following sections on Data Extractor, Database Generator, GUI Generator, and Search Engine Installer describe each search engine generation step in more detail. The Search Engine and Administrator sections explain how the resulting search engine, and administration component, are used and engineered. To avoid obscuring the unique aspects of each component, we do not repeat the details already provided in this overview section.

### Data Extractor

FIG. 3 shows the overall structure of Data Extractor, including its inputs and outputs. The user first specifies the format of the records in the source document, and then specifies the parameters that control data extraction. Data Extractor uses this information to parse the source document, creating a database schema and data. Database Generator uses these objects to perform its search engine generation task. The following paragraphs explain how Data Extractor is used and engineered.

As noted in the overview, Search Engine Generator takes a document as input. The source document, labeled Electronic Document in FIG. 3, may be in any format that can be stored on computer. For example, it may be a word-processed document in Microsoft Word, Corel WordPerfect, Adobe Acrobat, HTML, ASCII text, Unicode text, XML text, or other computer format. If the source document exists only in paper form, for example, as a paperback or hard cover book, or as a typewritten document, it can be scanned and processed through optical character recognition (OCR) software to generate an electronic, computer version of the text. This process is shown in FIG. 3 using the optional components labeled Paper Document and Scanner with OCR, which produce the electronic document, Electronic Document.

The source document will typically be written in a natural language such as English. However, Search Engine Generator's approach applies to binary or encrypted data as well. The only requirement for the source document is that it contains records that can be expressed with a context-free grammar whose tokens can be specified with regular expressions. For example, a “how to garden” book may contain instructions on selecting healthy plants, transplanting them, propagating them, and so on. Typically, such books also contain a reference section that lists plants with their care information, including soil, water, humidity, light, and temperature requirements. The entries in this reference section usually follow the same format. For instance, the entries for ficus and gardenia may appear on separate pages as

| Ficus | Gardenia |
|---|---|
| Flowers: none | Flowers: white |
| Bloom Period: none | Bloom Period: spring |
| Temperature: 62-85° F. | Temperature: 62-85° F. |
| Humidity: 40-50% | Humidity: over 50% |
| Soil: all-purpose | Soil: high humus |
| Light: east | Light: south |
| Water: evenly moist | Water: evenly moist |

The above entries are thus examples of structured data, or records, with a format consisting of eight fields, one per line: (1) a plant name followed by (2a) the word “Flowers:”; (2b) the flower color; (3a) the phrase “Bloom Period:”; (3b) the flowering season; (4a) the word “Temperature:”; (4b) a range of temperatures; (5a) the word “Humidity:”; (5b) the required humidity; (6a) the word “Soil:”; (6b) the required soil type; (7a) the word “Light:”; (7b) the required amount of sunlight; (8a) the word “Water:”; and (8b) the watering requirements. The first step of data extraction, then, is to specify the document's record format, which is represented by Record Specification in FIG. 3. The Search Engine Generator wizard provides a form to do so. It is shown in FIG. 12.

The record format specification form has a text area, called Record in FIG. 12, where the user enters the kind of information typically captured in a parser generator's and lexical analyzer generator's input languages. While compiler developers are familiar with these languages' features, other people usually are not. Therefore, the input language used within the form is simpler than that of most parser generators and lexical analyzer generators. It uses standard lexical elements for identifiers and numbers, for example, so that these need not be specified. It also deduces which tokens are the terminals and non-terminals, and which is the start symbol.

To specify the record format, users copy a sample record from the source document and paste it into the Record text area. They then edit the sample record to indicate which pieces of text always occur, which pieces are variable, and which are optional. They can also indicate if the text in a certain part of the record can appear in different formats, and what those formats are. Users may even specify formulas involving variables that occur anywhere within the record. They may also instruct Data Extractor to ignore certain portions of the text.

To illustrate, FIG. 12 shows the record format for the plant example in Paragraph [0045]. Note that the order in which the items appear in the specification must be the same order in which they appear within the source document.

We see that a record begins with a plant name; since plantName does not have double quotes around it, it's treated as a variable whose value will typically be different from record to record. The plant's name must be followed by the word Flowers; it appears in double quotes to indicate that it must always occur exactly as typed at that position in the record. (If the record contained the characters “Flowers” instead of Flowers, we would have specified this as “\“Flowers\”” within the Record field.) Similarly, the token after Flowers must be a colon, and then the actual flower color may be different from record to record. The blooming period has a similar format to that of the flower color, as do soil, light, and water requirements. The temperature has both a minimum and maximum temperature separated by a dash and followed by the degrees Fahrenheit symbols. The humidity information may be in one of two formats; it is either a range indicating the minimum and maximum humidity followed by the humidity symbol, or it is a minimum humidity preceded by the word over and followed by the humidity symbol.

The line beginning with integer in the Formulas field of FIG. 12 states that the temperature and humidity variables represent integer values. Since the other variables' types are not specified, they are assumed to be strings. The last two items in the Formulas field are formulas to calculate the minimum and maximum temperatures in degrees Celsius. Both formulas give a floating point number as their result. As in other programming languages, variables and constants used within formulas must be type-compatible. For example, two numbers may be added, but a number and a string cannot be added. Further, all the variables that occur in the Formulas field must be defined in the Record field. Types such as integer and float that appear in the Formulas field must be defined in the Numbers, Dates, or Booleans section of Record Specification's form, as discussed in Paragraphs [0052]-[0056]. Each statement in the Formulas field ends in a semicolon so that its parser knows where one ends and another begins.

The example in FIG. 12 does not include any text that the user wants to ignore, or that could be optional. To show how those could be specified, we provide another example. Suppose the plant description included information on its appearance and height, and that this information came after the blooming season. For ficus, this data might be
Appearance: Diverse. May be trees or trailing plants.
Height: some are at least 12 ft.
   For gardenias, it might be
Appearance: Shrub with dark glossy leaves.
Height: at least 2 ft.
   If the user wants to ignore the appearance information, which means he doesn't want to store it in the database to make the information available for searches, he could specify this as
“Appearance” ignore
   The word “Appearance” marks the end of the prior data item, the blooming period. Everything after the word “Appearance” will be ignored, up to but not including “Height”. As for the height, the phrase “some are” is optional and can occur zero or one time only. This could be specified as
“Height” “:” (“some are”)? “at least” height “ft.”
   Typically, the user would also state that the height is an integer, as he did for the temperature and humidity values. Record Specification also allows stating that an optional item may occur one or more times, or zero or more times; these are denoted with the standard regular expression notation of + and *.

The record format specification form also contains a section for defining types, such as the integer and float types used in the example. Since the natural language and country's customs determine the way a number, currency amount, percent, date, time, timestamp (a date and time), or Boolean value is written, a type definition consists of a format as well as a name. In FIG. 12, the Numbers drop-down list allows the user to select a number, currency amount, or percent. The Name field stores the new number type's name. The user chooses the format for numbers, currencies, and percents from the corresponding Format drop-down list containing examples formatted with each available locale that Java provides. These formats differ in the symbol used to denote negative numbers, its location within the number, the symbol used to separate thousands, the symbol used to separate the whole and fractional part of a number, the currency symbol, its location within the number, and the percent symbol.

Similarly, the Dates field in FIG. 12 allows selecting a date, time, or timestamp. The user enters its name in the corresponding Name field, and he specifies the format using the same format strings accepted by the Java class, java.text.SimpleDateFormat. For example, entering MMM dd, yyyy as the format would mean that dates within the source document appear as Mar. 20, 1996 instead of as Mar. 20, 1996 or some other date format.

For Boolean values, the user enters the type's name in the Booleans field of FIG. 12 and indicates how both true and false values are represented in the source document's records. For instance, if the source document is written in Spanish, true values might appear as cierto while false values may appear as falso. These values would be entered in FIG. 12's True and False fields, respectively.

Note that each type definition section has a Define more link. This is used to define additional types of the same kind, and its use is illustrated below.

FIG. 12 shows the definition of the integer type used within the record format specification. It is a number, as opposed to a currency amount or percent. Within the source document, negative integers are formatted with a minus sign in front of the number. The Format field also indicates that a comma is used to separate thousands, and that there is no decimal point or fractional part to the number. Examples of other integer formats within the Formats drop-down list are 1,234−, which is used in Arabic countries, −1′ 234, which is used in Switzerland, and −1.234, which is used in many European countries. While not shown in FIG. 12, the user would click the Numbers' Define more link to define the float type used within the record format specification. Once this link is clicked, the form would contain another row of Numbers, Name, and Format fields to specify a new number type. For the float type, the user would again select a number, but would choose −1,234.56 as the format to indicate that it may have a decimal point and fractional part.

These type definitions, including the format information, are also saved in Record Specification of FIG. 3.

Once the user finishes creating the record format specification, Record Specification of FIG. 3, he enters in FIG. 12's File field the name of the file where it should be saved and clicks the form's Next button to proceed to the second and last part of data extraction. If the record format specification already exists, the form's Browse button can be used to find it and transfer its contents to the form's fields; this process was described in Overview of the Search Engine Generation Process. FIG. 12's File field shows that the sample Record Specification will be saved in C:\GardeningManual\RecordSpecification.xml. It's worth noting that the data in the Record and Formulas fields are saved in XML format instead of as strings, but automatically converted with XSLT and XSL to the simpler, less verbose syntax used within the wizard's GUI. As with all XML files, Record Specification contains an element that stores the version of the XML schema language used to write it.

Since the next part of data extraction needs information from Record Specification, the Search Engine Generator servlet must parse Record Specification to fill in the next part's form. To do so, the servlet invokes Data Extractor's Record Specification parser. This parser consists of a parser for the Record field, another parser for the Formulas field, and code to store the form's numbers, dates, and Booleans within Java objects. In the preferred embodiment, the Record and Formulas fields' parsers are implemented in a standard way using a third-party lexical analyzer generator and a parser generator.

The Record Specification parser begins by calling the Record field's parser. It reads the data in the Record field and creates instances of the Java classes that model each construct it encounters. These objects may be literals (i.e., items beginning and ending with a double quote character), variables, choices, optional elements, or ignorable items as well as an object representing the entire specification. The specification object stores all the other objects, in the same order in which they appear within the Record field. In essence, the specification object is an abstract syntax tree that represents the grammar used to define the source document's records; the grammar's start symbol is the first object in the specification object, the grammar's terminal symbols are the literals' values, and the grammar's non-terminal symbols are the objects that model the specification and its individual items. The Record field's parser also stores variables in a hash table so they will be readily accessible when a formula's value must be computed, or when a type declaration is processed requiring that the variable's type be changed.

Next, the Record Specification parser calls the Formulas field's parser. It reads the data in the Formulas field and creates instances of the Java classes that model each construct it encounters. These objects may be type declarations or formulas. While processing type declarations, it retrieves the variables from the hash table and updates their type attribute, issuing an error if the variable wasn't found. Similarly, it issues errors if it can't find the variables occurring in formulas, or if these variables aren't type-compatible with the other terms used to calculate the formula. The Formulas field's parser adds these objects to the end of the specification object that the Record field's parser created, and adds them in the same order that they appear in the Formulas field.

The Record Specification parser ends by storing the numbers, dates, and Booleans defined within Record Specification's wizard form. For each type definition, it creates an instance of the Java class that represents it. The classes for numbers and dates have an instance variable to store the base type, another to store the type's name, and another to store its format. The class for Booleans has an instance variable to store the type's name, another to store its true value, and a third instance variable to store its false value. The parser copies the base type from the form's Numbers or Dates field into the object's base type attribute. Similarly, it sets the number's or date's name attribute by copying the value from its Name field, and its format by copying the value from its Format field. For Booleans, the type's name attribute is set with the value in its Booleans field, while its attributes for true and false values are set with the data in its True and False fields, respectively. The parser adds these type definition objects to the end of the specification object, in the same order that they are defined within Record Specification's wizard form. When the parse finishes, the servlet uses standard get methods on the specification object to retrieve the values it needs to fill in the last form of the data extraction step.

In the second and last part of data extraction, the user specifies the values for several parameters that control Data Extractor's actions. These eight parameters are described in the following paragraphs, and are represented by Extractor Configuration in FIG. 3. FIGS. 13 and 14 contain the top and bottom halves of the wizard form for entering these parameters.

The first parameter is the default natural language to use within the GUI, represented as Language in FIG. 13. This must be the language in which the document is written, and is English in our example. The only exception is for source documents containing binary data; for these, the user may select any natural language he wishes as the default. The user must choose the natural language from Search Engine Generator's list of supported natural languages.

The second parameter is the full path name of the file or files containing the source electronic document. If there is more than one such file, they must be ordered sequentially, with the first file containing the start of the document, the next file containing the next section, and so on. These files are the Document items of FIG. 13, whose Browse button may be used to select the desired file via a standard file chooser dialog box as illustrated in FIG. 11. For each file, the user also enters a short description of the file's contents, using the same natural language specified by the first parameter. These descriptions are the Contents items of FIG. 13. For efficient data extraction, the document's records must be in a separate file or files; the user must indicate which files contain the records by checking the Has Records box next to the files' name. FIG. 13's Specify more link is used to add more Document, Contents, and Has Records fields to the form, so that additional source document files may be entered. To delete source document files, the user would merely delete the information entered into its fields on the form. In the example of FIG. 13, we see that the source document consists of two files; the first one contains general instructions on gardening and a bibliography, but no records, while the second one is the plant catalog containing the document's records.

The third parameter is the full path name of the file containing the record format specification, Record Specification. This value is copied from the prior form. It appears in FIG. 13 as Record Specification; its Browse button can be used to navigate to another file.

The fourth parameter is which fields of the document's records are of interest for searches; these are the ones that will be stored in the generated database. By default, all fields are used, where any variable or formula occurring in Record Specification is considered to be a field. Given the example of the gardening book in FIG. 12, the plant's name, flower color, bloom period, minimum and maximum temperature in both degrees Fahrenheit and Celsius, minimum and maximum humidity requirements, soil type, lighting, and watering requirements would all be used unless otherwise indicated. FIGS. 13 and 14 display these fields in the table column called Column Name. The values in this column are based on variable and formula names used in Record Specification, and show how the fields will be called in the database. The figures' Extract column displays an HTML checkbox control next to each field; since each one is checked, each field will be stored in the database.

For each field, the form also provides a default column heading for use within reports displaying the results of a search, and a default data type; these appear in the Column Heading and Data Type columns of FIGS. 13 and 14. For numbers, currencies, percents, dates, times, timestamps, or Boolean values, the form also provides a default format, shown in the Format column of FIGS. 13 and 14. The default column headings are based on the last keyword occurring before the variable in Record Specification; if there is no such keyword, the variable or formula name is used for the column heading. (A keyword is a string that begins and ends with a double quote, and contains letters and possibly other characters.) The default data type is always a variable length character string unless the user provided the type within Record Specification. In that case, a SQL type corresponding to the variable's or formula's type is used as the default type; compatible SQL types are deduced from the variable's or formula's base type and format, as illustrated below. The default format comes from the type definition stored in Record Specification.

For the gardening book example in FIG. 12, the form might suggest the following column names, headings, and data types; we omit the number formats for brevity.

| Extract | Column Name | Column Heading | Data Type |
|---|---|---|---|
| [symbol] | plantName | plantName | Varchar(250) |
| [symbol] | flowerColor | Flowers | Varchar(250) |
| [symbol] | bloomPeriod | Bloom Period | Varchar(250) |
| [symbol] | minTemp | Temperature | Integer |
| [symbol] | maxTemp | Temperature | Integer |
| [symbol] | minHumidity | Humidity | Integer |
| [symbol] | maxHumidity | Humidity | Integer |
| [symbol] | soil | Soil | Varchar(250) |
| [symbol] | light | Light | Varchar(250) |
| [symbol] | water | Water | Varchar(250) |
| [symbol] | minTempCelsius | minTempCelsius | Real |
| [symbol] | maxTempCelsius | maxTempCelsius | Real |

The user may override any default, but to change a column's name he must go back to the prior form to edit the corresponding variable or formula name in Record Specification.

New data types are selected from a drop-down list that includes only the SQL types compatible with the type entered in Record Specification; these drop-down lists are shown in the Data Type column of FIGS. 13 and 14. For example, minTemp is an integer in Record Specification. Within Record Specification, integer is defined as a number whose format is −1,234. So it may be represented in SQL as an Integer or Smallint. Similarly, Record Specification defines the minimum and maximum temperatures in degrees Celsius as having type float. As explained in Paragraph [0056], a float has a base type of number and a format of −1,234.56. That means it can be represented in SQL as Real, Double Precision, Float, Numeric, or Decimal. These SQL types are also used for the percents and currencies defined in Record Specification. Dates defined within Record Specification would be represented in SQL as having type Date, times would correspond to the SQL Time type, and timestamps would be mapped to SQL's Timestamp type. Since not all RDBMSs support a Boolean type, Record Specification's Boolean types are represented as SQL fixed-length character strings whose length is the length of the true or false value, whichever is longer. In the Boolean type example of Paragraph [0054], cierto is longer than falso, so the length of the SQL fixed-length character string representing this type would be 6. If a different SQL type is required, the user must go back to the prior form to edit the variable's or formula's type within Record Specification.

New formats are specified as they were in Record Specification. For numbers, currencies, and percents, the user chooses the desired format from the drop-down list of examples formatted with each available locale that Java provides. For dates, times, and timestamps, he enters the new format, expressed in the same format strings accepted by java.text.SimpleDateFormat. For Boolean types, he enters the new way to represent true and false values. As an example, suppose the source document had been written in Spanish as used in Spain. A temperature might appear as 23,5 within the source document; its format in Record Specification is thus −1.234,56. However, if the resulting search engine is intended for use within Mexico, that same temperature should be formatted as 23.5 when it appears within the search engine's GUI. So the user would have to change its format to −1,234.56.

Referring to the example in Paragraph [0069], the user may replace the plantName column heading with Plant Name, the Temperature headings with Minimum Temperature (° F.) and Maximum Temperature (° F.), the Humidity headings with Minimum Humidity (%) and Maximum Humidity (%), the minTempCelsius heading with Minimum Temperature (° C.), the maxTempCelsius heading with Maximum Temperature (° C.), and the data type from Varchar(250) to Varchar(50). FIGS. 13 and 14 show the result of these changes along with the formats as defined in Record Specification.

The fifth parameter for data extraction is the name of the new table that will store the selected fields' data. A default name, such as Table 1, is used if none is supplied. This parameter appears as Table Name in FIG. 14, and its value is Plants.

The sixth parameter is the field or fields that form the table's primary key. For the gardening example in Paragraph [0073], the user would enter plantName for this parameter's value in the Primary Key text box of FIG. 14.

The seventh parameter is the full path name for the file that will contain the new table's definition. This file is labeled Database Structure in FIG. 3. In FIG. 14, this parameter is denoted Database Structure and its value is C:\GardeningManual\DatabaseStructure.xml. An existing file can be selected with the Browse button.

The eighth and final parameter is the full path name for the file that will contain the actual data. This file is labeled Data in FIG. 3. Data of FIG. 14 refers to this parameter, whose value is C:\GardeningManual\Data.xml in this example. Again, the Browse button can be used to select an existing file.

The main component of Data Extractor, labeled Data Extractor in FIG. 3, uses Record Specification to guide the actions of the parser that reads the source document, Electronic Document. This parser is subclassed to handle various file formats, such as those of Microsoft Word, Corel WordPerfect, Adobe Acrobat, HTML, XML, and plain text; more subclasses can be added to handle other file formats. These subclasses differ in the tokens they consider to be formatting instructions, which depend on the source document's file format. In HTML and XML files, for example, the information contained within angle brackets, including the angle brackets, is considered to be formatting instructions. For instance, if the source document is written in HTML and contains <b>African Violet</b>, then the subclass of the source document parser that handles HTML files would consider <b> and </b> to be formatting information that is not part of the record for African violets. The source document parser ignores formatting instructions that it encounters while parsing the document's records.

To parse Electronic Document, Data Extractor determines the source document's file type based on its extension, as noted below. More file extensions can be added to handle other file types, but these would require adding a corresponding parser, as noted in the prior paragraph.

| File Extension | File Type |
|---|---|
| doc | Microsoft Word |
| wpd | Corel WordPerfect |
| pdf | Adobe Acrobat |
| html | HTML |
| htm | HTML |
| xml | XML |
| txt | Plain text, i.e., ASCII or Unicode |

Data Extractor then invokes an instance of the corresponding subclass of the source document parser.

The source document parser opens the first file containing records, and reads its first line. It passes the line to the first object within the specification object created from Record Specification as noted in Paragraph [0060]. This object creates an object to represent the data it needs to extract from the source file. It then parses the line, looking for the literal text or other items specified by itself, and stopping when it encounters the start of the next object in the specification or the end of the source document. The next object in the specification creates an object to represent the data it needs to extract, and then continues the parse where the first object left off. This process repeats until all objects in the specification have parsed their section of the source document. The retrieved record is then formatted in XML and saved in Data of FIG. 3, as detailed later in this section. Parsing then resumes with the first object in the specification object, since there may be more than one record in the source document. Parsing is complete when all source files containing records have been processed.

As with all parsers, it must be possible for the source document parser to determine where one value ends and another begins. In our gardening book example in FIG. 12, for instance, all fields except the first begin with a literal that marks the end of the prior field's data and the beginning of the next field. If there is no such literal in the source document, and if even white space such as blanks, tabs or new lines cannot be used to mark the end of the field, then the user must specify a fixed length for the field. He does so by entering the fixed length in Record Specification after the variable name or ignore keyword. For example, SSN:11 denotes that the field containing the Social Security Number has a fixed length of 11 characters.

By default, the parser ignores white space in the source document. In some cases, however, the white space may be significant. For instance, a new line may be the only way to tell that one field has ended and another is beginning. In such cases, the user should quote white space characters within Record Specification just as he quotes other literals. As an example, consider a record in which the plant's scientific name is followed by the plant's common name, each on its own line.
Gardenia jasminoides
Gardenia
   If the user specified this format as
scientificName
commonName
   the parser wouldn't be able to tell where the scientific name ends and the common name begins. The user must instead specify this record format as
scientificName “\n”
commonName
   where “\n” denotes the new line character. Similarly, a tab character can be denoted with “\t”, and a blank space with “ ”. The user can specify a variable number of white space characters with standard regular expression notation. For example, (“ ” | “\t” | “\n”)+ means there are one or more white space characters, and they can be spaces, tabs, or new lines.

The action the source document parser takes depends on the type of object being parsed. If the object represents data that can be ignored, the parser reads the source file until it encounters the start of the next object in the specification, or until it reads the number of characters specified for ignorable fields of fixed length, not including any formatting instructions. In the preferred embodiment, the parser saves the retrieved information within the object representing the data that can be ignored; it may be needed for debugging or for providing meaningful parser error messages.

If the object being parsed is a literal, i.e., an item beginning and ending with a double quote character as specified in Record Specification, the parser reads the source line looking for the first character after the starting double quote, which may be on another line. Thus, the parser may read additional lines. It reads as many characters as there are in the expected literal, the one stored in the object doing the parse, but it ignores formatting instructions that it encounters. The parser compares the literal it retrieved from the source file with the expected literal. If they match, the parse succeeded; otherwise, it notifies the user of the error. Since literals are not stored in the database, the parser does not have to perform any actions with the literal; it merely keeps track of the position in the line just after the literal's last character.

When parsing a variable's value, the parser's actions depend on its type. For strings and Boolean values, it merely reads the source file, saving all characters it finds until it encounters the start of the next object in the specification, or until it has read the required number of characters for fixed-length fields; however, it ignores formatting instructions. For Boolean values, it then compares the retrieved string to the expected format for true and false values. If there's a match with either one, it saves the corresponding Java Boolean value in the variable along with the retrieved value; otherwise, it signals an error. For numbers, currencies, percents, dates, times, or timestamps, the parser first skips over any formatting instructions, and then uses standard Java classes to retrieve the value according to the format the user had specified, as noted in Paragraphs [0052]-[0053]; this format is saved in one of the variable's attributes. Regardless of its type, the retrieved value is stored in an attribute representing the variable's value. The parser stores the variable in a hash table so that its value can be found easily if it's needed to compute a formula.

Choice objects store a list of all the possible choices. The parser determines which of the possible choices may match the token at that point in the source file, after skipping any formatting instructions. For example, if the current token is a letter, choices that begin with a literal starting with the same letter are a possible match, but those that begin with numbers are not. As it continues to read tokens, the parser compares them to the item that must occur at that point in each possible remaining choice, ignoring any formatting instructions. If there are no errors in the specification or the source document, the parser will eventually narrow down the set of possible matching choices to only one. The individual elements within the matching choice are literals, variables, or ignorable items; they're processed as noted earlier. Optional elements within the choice are parsed and processed as noted in the next paragraph.

Objects modeling optional items contain a list of the information that is optional, as well as an attribute denoting how many times the optional item may occur. These optional items ultimately consist of literals, variables, ignorable data, choices, or other optional items. After skipping any formatting instructions, the parser decides if the current token could be part of the optional item. For example, if the current token is a letter, and the optional item begins with a literal that starts with the same letter, then the token could be part of the optional item. However, if the literal in the source document is “at least” and the optional item's literal is “some are”, then the optional item does not occur. This is fine as long as the optional item may occur zero times, but signals an error if it must occur at least one time. Thus, the parser not only checks if the information is in the source file, but also if it occurs the number of times it is allowed to occur. As with other parsing operations, it stops looking for optional items as soon as it encounters the start of the next object in the specification.

For formulas, the parser doesn't have to read the source file. It just uses the hash table to look up the current value of each variable that occurs in the formula, and then evaluates the formula with those values. It stores the formula's result in the attribute defined for that purpose.

Data Extractor generates two items using the parsed information. The first is a file containing the structure of the data, labeled Database Structure in FIG. 3. This is an XML file containing elements for specifying the default natural language, a table's name, its column names, column headings in the default natural language, data types, formats, primary key information, and full path name of the file or files containing the source electronic document, along with a description of each file's contents. The values for these elements come from the Extractor Configuration component. It also provides an element for specifying the version of the XML schema language being used; Data Extractor provides its value. The file's location and name is that specified with Extractor Configuration, as noted in Paragraph [0076]. The source document parser creates Database Structure when it begins to execute.

The second and last item that Data Extractor creates is a file containing the structured data, labeled Data in FIG. 3. This is also an XML file, but it has elements for specifying the version of the XML schema language being used, the name of the database table into which records are to be inserted, and a list of records. Each record is a list of pairs consisting of a column name and its value. There's one such pair per source document field that the user wants to store in the database. The source document parser initializes Data after it creates Database Structure. It creates the file in the location specified with Extractor Configuration, as noted in Paragraph [0077], and outputs the XML schema language version number, the table name, and the opening XML elements for the list of records; the rest of the elements' values depend on individual records.

When it processes a complete record from the source document, the parser writes to Data the column name and column value pairs noted in Paragraph [0090]. The column names come from Extractor Configuration, and the column values are stored in an attribute of each variable or formula object that the source document parser created.

When the entire source document has been parsed, the parser outputs to Data the closing top-level XML elements, and closes the file.

### Database Generator

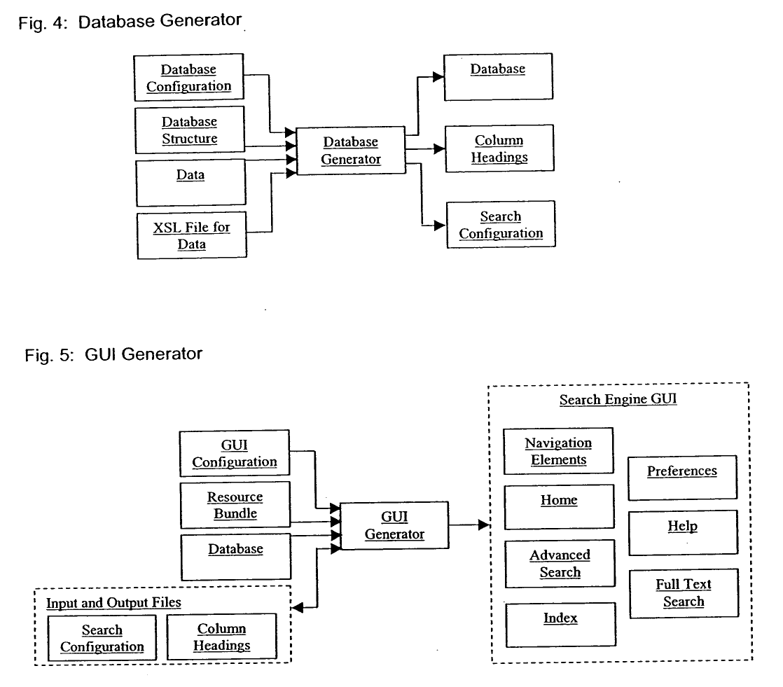

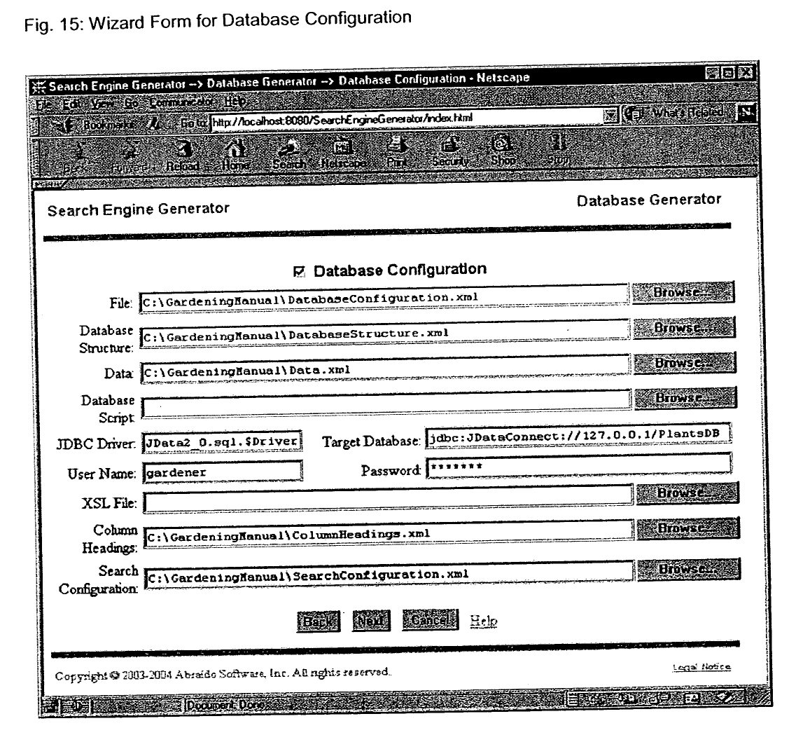

FIG. 4 shows the inputs to, and outputs from, the Database Generator component. Note that the inputs labeled Database Structure and Data were created with the component labeled Data Extractor in FIG. 3. Database Configuration is an XML file in which Search Engine Generator's user specifies values for the parameters that control the database generation process. The user enters these ten parameters with the Search Engine Generator wizard as shown in FIG. 15. The parameters are described below.

The first parameter is the full path name of Database Structure. This is the same full path name that was specified with Extractor Configuration, as noted in Paragraph [0076]. The wizard copies the value from Extractor Configuration. In FIG. 15, it's the Database Structure field.

The second parameter is the name of Data. This is the same full path name that was specified with Extractor Configuration, as noted in Paragraph [0077]. The wizard also copies this value. FIG. 15 shows it as the Data field.

The third parameter is the full path name of the script to use to create the target relational database, if a new database is desired. This script also creates any objects that the selected JDBC driver described in the next paragraph requires to access the new database. For example, if Search Engine Generator is running on Microsoft Windows, it creates a DSN entry for the database. If the target RDBMS does not allow programmatic creation of new databases, Search Engine Generator's user must create the target relational database, and any objects the JDBC driver requires, before database generation begins. In the example of FIG. 15, the Database Script field is blank, so the database already exists.

The fourth parameter is the JDBC driver to use to connect to the target relational database. This parameter is shown as JDBC Driver in FIG. 15, and its value is the name of the JDBC driver's Java class.

The fifth parameter is the location of the target database server, including the name of the target relational database. In FIG. 15, it's the Target Database field. Note that its value is the string to pass to Java's java.sql.DriverManager.getConnection method to establish a connection with the database using the selected JDBC driver. Since Search Engine Generator is running on Microsoft Windows in this example, the string includes the target relational database's DSN, which is PlantsDB.

The sixth parameter is the name of the user that should connect to the target relational database, and is the User Name field of FIG. 15. In the preferred embodiment, a standard encryption approach is used to encrypt the value for storage to prevent unauthorized connections to the database.

The seventh parameter is that user's password for the target relational database, and is FIG. 15's Password field. In the preferred embodiment, it is also encrypted for storage to prevent unauthorized connections to the database.

The eighth parameter is the full path name of the XSL file to translate between the XML used in Data and the relational database's XML representation of the data. This is needed for RDBMSs that are XML-enabled, meaning that they provide data transfer between the database and an XML representation of the data. In FIG. 15, the XSL File field is blank, so this example doesn't use an XML-enabled database.

The ninth parameter is the full path name for the file that will contain the column headings. This parameter appears as Column Headings in FIG. 15.

The tenth and final parameter is the full path name for the file that will contain configuration parameters for searches. It is the Search Configuration field of FIG. 15.

The main database generation component, labeled Database Generator of FIG. 4, gets as an input parameter the object representing the information in the configuration file, Database Configuration; the Search Engine Generator wizard created this object. Database Generator uses a standard SAX parser and XSLT with an internal XSL to transform the contents of Database Structure into a SQL create table statement with the table name, column names, data types, and primary key information specified in this XML file. The SQL for the gardening manual that we're using as an example appears below.

```
create table Plants (
  plantName Varchar(50),
  flowerColor Varchar(50),
  bloomPeriod Varchar(50),
  minTemp Integer,
  maxTemp Integer,
  minHumidity Integer,
  maxHumidity Integer,
  soil Varchar(50),
  light Varchar(50),
  water Varchar(50),
  minTempCelsius Real,
  maxTempCelsius Real,
  primary key (plantName)
)
```

Afterwards, it uses another standard SAX parser, XSLT, and XSL to transform Data's contents into the format accepted by the target relational database management system. If this RDBMS is XML-enabled, it'll use the XSLT and XSL to translate Data's contents to the target database's XML representation of the data; XSL File for Data in FIG. 4 represents this user-supplied stylesheet, as noted in Paragraph [00101]. Otherwise, it'll translate Data's contents to SQL insert statements using an internal XSL file. There will be one insert statement per record in the source electronic document. The first two SQL insert statements corresponding to our gardening manual's records are shown below. There would be similar entries for ficus and gardenia, as well as the other plants in the gardening manual.

```
insert into Plants (
  plantName, flowerColor, bloomPeriod, minTemp, maxTemp,
  minHumidity, maxHumidity, soil, light, water, minTempCelsius,
  maxTempCelsius )
values (
  “African Violet”, “white”, “spring”, 62, 85,
  50, null, “high humus”, “east”, “evenly moist”, 16.67, 29.44
)
insert into Plants (
  plantName, flowerColor, bloomPeriod, minTemp, maxTemp,
  minHumidity, maxHumidity, soil, light, water, minTempCelsius,
  maxTempCelsius )
values (
  “Amaryllis”, “white”, “spring”, 50, 70,
  40, 50, “all-purpose”, “south”, “evenly moist”, 10.00, 21.11
)
```

Then, if Database Configuration specifies a script, Database Generator executes this script to create the target relational database and any objects that the selected JDBC driver requires to connect to the database; for example, these may include a DSN. Otherwise, it assumes the target relational database and required objects already exist.

Database Generator proceeds to connect to the target relational database. It uses the JDBC driver, database server location, user name, and user password specified in Database Configuration for this purpose. Once connected, Database Generator executes the SQL create statement it generated in a prior step to create the new table. It then populates the table with data by executing the SQL insert statements created in a prior step; for XML-enabled relational databases, it instead transfers the data in the XML format described in Paragraph [00105]. The end result is the component labeled Database in FIG. 4, a relational database containing a new table holding all the source document's records.

Next, Database Generator creates the component labeled Column Headings in FIG. 4. This is an XML file named as specified in Paragraph [00102]. Apart from the element storing the version of the XML schema language in which it is written, this file contains two items. The first is a list containing the name of each column forming the primary key. The second element is a list of one element. The element is a pair whose first item is the name of the default natural language, as noted in Paragraph [0089], and whose second item is a list of column name, column heading, and format triples; these values come from Database Structure. Using the example of Paragraph [0073], but omitting the XML elements and denoting formats with an ellipsis ( . . . ) for simplicity, the main content of Column Headings might look something like

```
( plantName ),
( ( English, ( (plantName, Plant Name, ...),
          (flowerColor, Flowers, ...),
          (bloomPeriod, Bloom Period, ...),
          (minTemp, Minimum Temperature (° F.), ...),
          (maxTemp, Maximum Temperature (° F.), ...),
          (minHumidity, Minimum Humidity (%), ...),
          (maxHumidity, Maximum Humidity (%), ...),
          (soil, Soil, ...),
          (light, Light, ...),
          (water, Water, ...),
          (minTempCelsius, Minimum Temperature (° C.), ...),
          (maxTempCelsius, Maximum Temperature (° C.), ...)
        )
  )
)
```

In this case, the primary key is formed by only one column, plantName.

Database Generator finishes by creating the component labeled Search Configuration in FIG. 4. This configuration file contains the parameters that allow a search engine to connect to the database and access its new table, or to display the full text of the source electronic document. It's an XML file named as specified in Paragraph [00103], and contains elements for specifying the version of the XML schema language being used, the JDBC driver to use to connect to the target relational database, the location of the target database server, including the name of the target relational database, the name of the user that should connect to the target relational database, that user's password for the target relational database, the name of the table containing the data, the full path name to Column Headings, the full path name to the file or files containing the source electronic document, and the description of each source file's contents. Database Generator provides the XML schema language's version number. The name of the table, path to the electronic document, and descriptions of each source file's contents come from Database Structure; the values for the other elements come from the corresponding values in Database Configuration. In the preferred embodiment, a standard encryption method is used to encrypt the user name and password to prevent unauthorized access to the database.

### GUI Generator

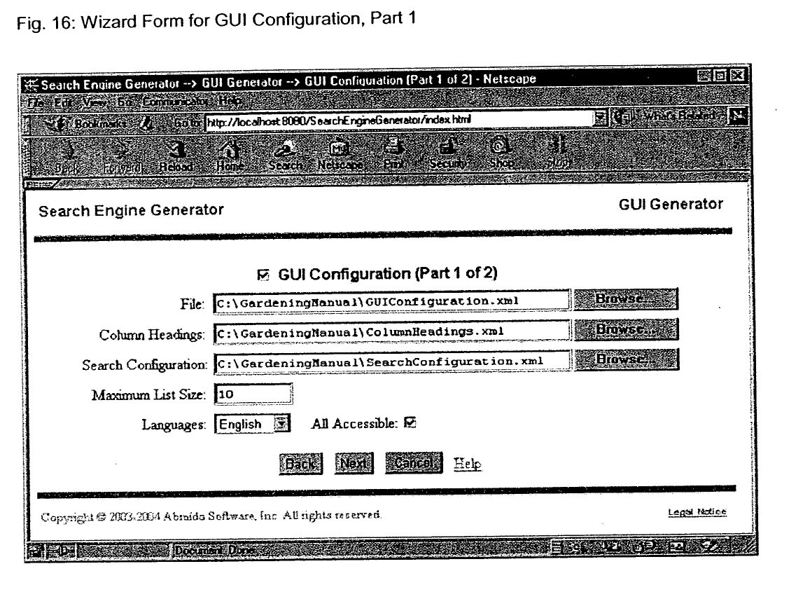

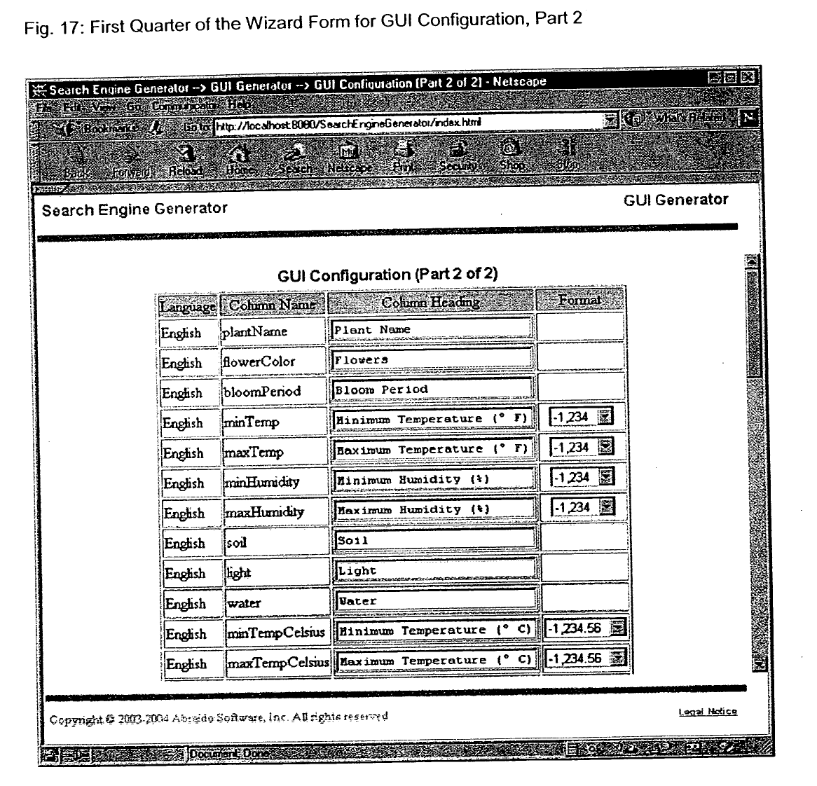

FIG. 5 shows the inputs to, and outputs from, the GUI Generator component. Note that the components labeled Column Headings, Search Configuration, and Database were created with the component labeled Database Generator in FIG. 4. GUI Generator uses Column Headings and Search Configuration, but also modifies them, which is why they're shown as Input and Output Files in FIG. 5. GUI Configuration is an XML file in which Search Engine Generator's user specifies values for the parameters that control the GUI generation process. There are eleven such parameters, which the user enters with the Search Engine Generator wizard forms shown in FIGS. 16-20. Since six of these parameters depend on a value entered for another parameter, the wizard presents the user with two forms to fill out. In the first form, shown in FIG. 16, the user enters the first five configuration parameters; the servlet uses the value of one of these to partially fill out the second form, shown in FIGS. 17-20, where the user enters the remaining six parameters. All eleven parameters are described in the following paragraphs.

The first parameter is the full path name to the Column Headings file that Database Generator created as noted in Paragraph [00108]. For convenience, the wizard copies this value from Database Configuration. It is the Column Headings field of FIG. 16.

The second parameter is the full path name to the Search Configuration file that Database Generator created as noted in Paragraph [00109]. The wizard copies this value from Database Configuration into the Search Configuration field of FIG. 16.

The third parameter is the maximum number of values to add to a drop-down list in the graphical user interface. It's represented by the Maximum List Size field of FIG. 16.

To facilitate international distribution or access of the search engine, the fourth parameter is the list of natural languages in which to generate the GUI. The user chooses these from the list of natural languages that Search Engine Generator supports, which appears in FIG. 16 as the Languages field. The list of supported natural languages is stored in Resource Bundle of FIG. 5.

The fifth parameter, denoted by the All Accessible field of FIG. 16, determines if all the selected natural languages are accessible from the same search engine. If so, the search engine's user will be able to change the natural language used within the GUI. Otherwise, only one natural language is accessible at run time. For instance, if the search engine will be deployed on the Internet, Search Engine Generator's user may choose to make the various natural languages accessible from the search engine for the convenience of its international users. However, if the search engine will be installed on a corporate intranet, Search Engine Generator's user may decide that only one language need be accessible from each search engine. In this case, the Spanish version of the search engine would be installed in the company's Spanish-speaking offices, whereas the English version would be installed in offices where the native language is English.

Once the user enters the first five parameters and clicks the wizard's Next button, the servlet uses the list of natural languages entered as the value of the fourth parameter to calculate the contents of the next form and to partially fill in its values. In particular, it creates a table containing each natural language listed in the fourth parameter. For each language, the table contains the full list of column names from Column Headings, which the servlet read with a standard SAX parser. The table also contains the column headings in the default natural language as well as number, currency, percent, date, time, timestamp, and Boolean formats, since that information is available in Column Headings as well. For the other natural languages, the column headings are blank; the user needs to enter a value for each one. He may also enter new formats for any column whose type is a number, currency, percent, date, time, timestamp, or Boolean. The information in this table represents the value of the sixth parameter for GUI configuration. All the values entered in this table will replace those in Column Headings when the user clicks the wizard's Next button.

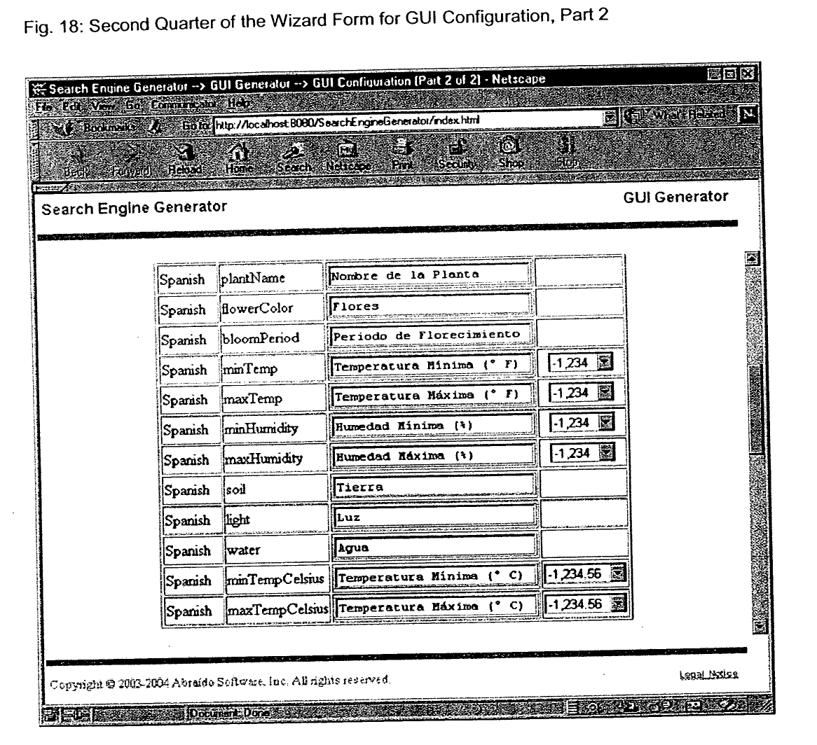

To illustrate these points, consider the example of Column Headings from Paragraph [00108], and assume the user entered English and Spanish as the values of the fourth parameter discussed in Paragraph [00114]. FIGS. 17-18 show the table with column names, column headings, and formats after the user enters the column headings in Spanish.

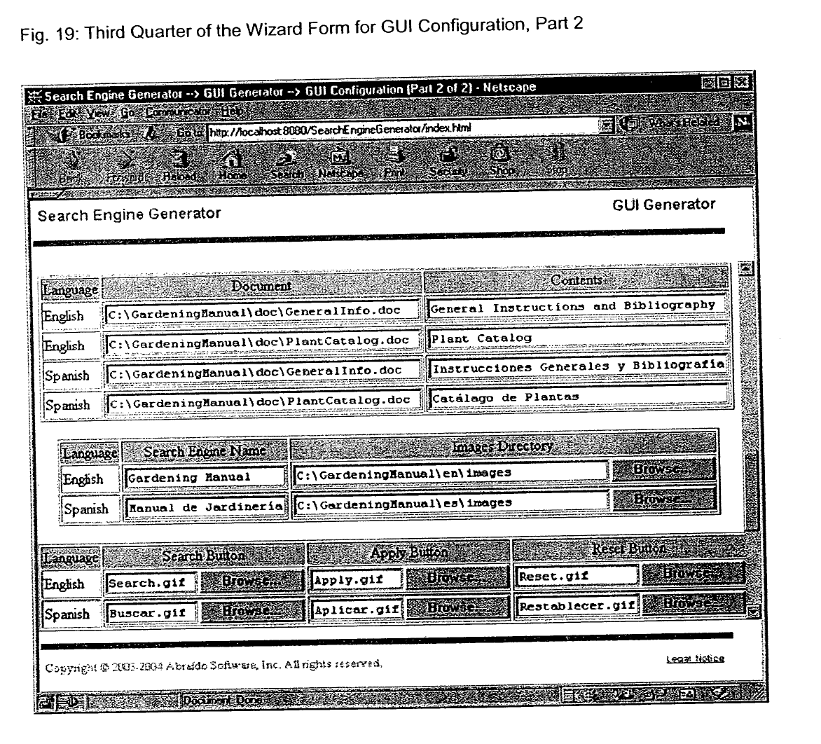

Similarly, the servlet creates a table containing each natural language along with the list of source document file names and descriptions. The servlet used a standard SAX parser to read Search Configuration to get the source document file names and their descriptions in the default natural language. For the other natural languages, the descriptions are blank; the user needs to enter a value for each one. The information in this table represents the seventh parameter of GUI configuration. The new values will replace those in Search Configuration when the user clicks the wizard's Next button. FIG. 19 shows the table with source document file names and descriptions after the user enters the descriptions in Spanish.

The form also contains a table to enter the eighth GUI configuration parameter, which is a list of six elements consisting of the name of a natural language, the search engine's name phrased in that natural language, the full path name of the directory containing the images to use for the search, apply, and reset buttons, and the names of the files containing the search, apply, and reset button images. The servlet fills in the name of each natural language supplied as noted in Paragraph [00114], and the user enters the remaining information. The search engine name will be displayed in the graphical user interface; it will typically be the source document's title. The bottom two tables in FIG. 19 show this information after the user has entered the data in both English and Spanish.

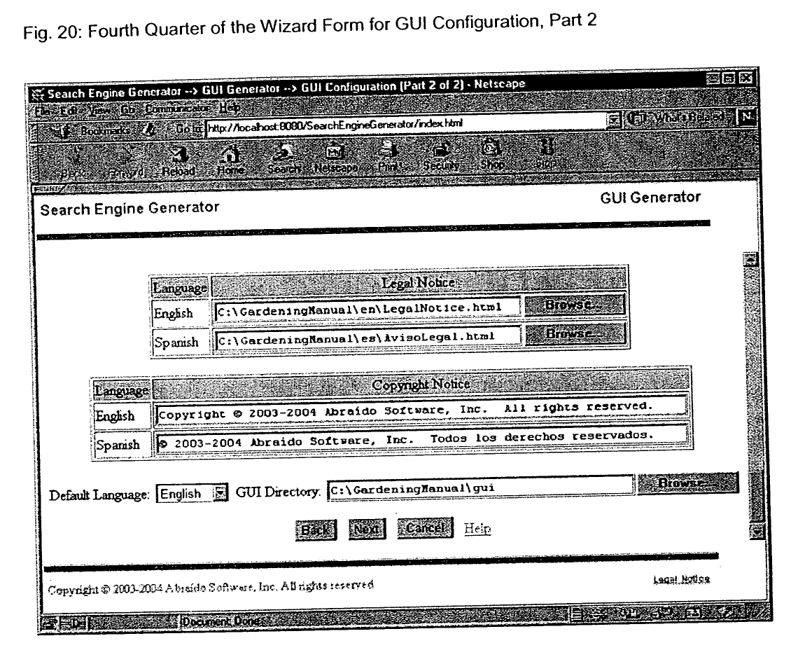

The ninth parameter is a list containing as many elements as there are natural languages in the fourth parameter (Paragraph [00114]). Each element is a triple consisting of a natural language from the fourth parameter, the full path name of the user-supplied file containing the search engine's legal notice in that natural language, and the search engine's copyright notice in that language. The form displays two tables where the natural languages are already filled in, and the user enters the remaining information. FIG. 20 shows these tables after the user has entered the data in both English and Spanish. For Web-based search engines, the legal notice files are written in HTML; for other kinds of search engines, the files are written in the target platform's online help system.

The tenth parameter is the default natural language to use within the GUI. It's the Default Language field in FIG. 20, and its value is copied from Column Headings; the other values in the drop-down list are the values entered for the fourth parameter of GUI Configuration. The natural language specified with this tenth parameter will be used whenever starting a search engine that allows switching between all the chosen natural languages. It'll also be used within a search engine if a translation in the current natural language is missing. This may occur if Resource Bundle is edited but left in an inconsistent state.

The eleventh and final parameter is the full path name to the directory where GUI files should be put. It's the GUI Directory field in FIG. 20.

GUI Generator also uses FIG. 5's Resource Bundle, an XML file that stores bundle names along with their key/value pairs. Resource Bundle also contains an element that stores the version of the XML schema language in which the file is written. GUI Generator reads this file with a standard SAX parser that creates standard Java ResourceBundle objects; these objects allow GUI Generator to create the search engine's internationalized and localized user interface.

Resource Bundle contains a bundle for the natural languages that GUI Generator supports, and separate bundles for each of the pages that the generator creates. For example, if GUI Generator supports only English and Spanish, then Resource Bundle may contain the Languages bundle whose languageNames key has the default value of English, Spanish. In this case, Resource Bundle would also contain the Languages_es bundle with its languageNames key set to inglés, español. If Search Engine Generator is running in English, it displays English and Spanish in the list of supported natural languages from which the user may select the value for the fourth parameter noted in Paragraph [00114]. However, if Search Engine Generator is running in Spanish, it displays inglés and español instead.

For the pages that GUI Generator creates, Resource Bundle defines a bundle for the page's title, expressed in GUI Generator's default natural language. Separate bundles store the page's title in each of the natural languages that GUI Generator supports. Additional bundles store titles for the page's controls or other content.

The main GUI generation component, labeled GUI Generator in FIG. 5, gets one input parameter; it was created with the Search Engine Generator wizard. This parameter is the object representing the information in the configuration file, GUI Configuration. GUI Generator uses the information in GUI Configuration and Resource Bundle to create six to seven XML files, as described in the following paragraphs. There is one set of files for each selected natural language as given by the fourth parameter. GUI Generator creates each language's files in a subdirectory whose name is the ISO 639 two-letter code for the language's name. For example, it puts the XML files containing English content in the en subdirectory, while XML files containing Spanish content go in the es subdirectory.

Each XML file begins with a declaration that identifies it as an XML file. An example is <?xml version=‘1.0’ encoding=‘us-ascii’?>, which declares the file as an XML document that conforms to version 1.0 of the XML specification. The declaration also states that the file uses the US-ASCII 7-bit character-encoding scheme. This is an excellent choice for the gardening manual's search engine written in English, since it'll create the most compact documents possible. For the Spanish version, however, GUI Generator selects the UTF-16 character-encoding scheme: <?xml version=‘1.0’ encoding=‘utf-16’?>.

Each XML file is written in its own XML schema language, as noted below. Each XML schema language includes an element whose attributes identify the page and the version of the schema language being used. GUI Generator supplies the value for these attributes. For the home page, an example is <page xmlSchemaVersion=“1.0” name=“home”>. Note that the page's name attribute has the same value, regardless of the natural language used for the file's contents. This attribute is used for programming purposes. All the other XML elements are defined within the page element.

Each XML schema language also defines an element to represent the search engine and its properties, such as the way to invoke the servlet or main program; an attribute stores the search engine's title in the natural language used for the file's contents. The corresponding elements for the gardening manual search engine are shown below. The first one is in the XML file containing the English GUI, while the second is in the XML file for the Spanish GUI.

| | |
|---|---|
| <searchEngine title=“Gardening Manual” /> | <!-- English file --> |
| <searchEngine title=“Manual de Jardinería” /> | <!-- Spanish file --> |

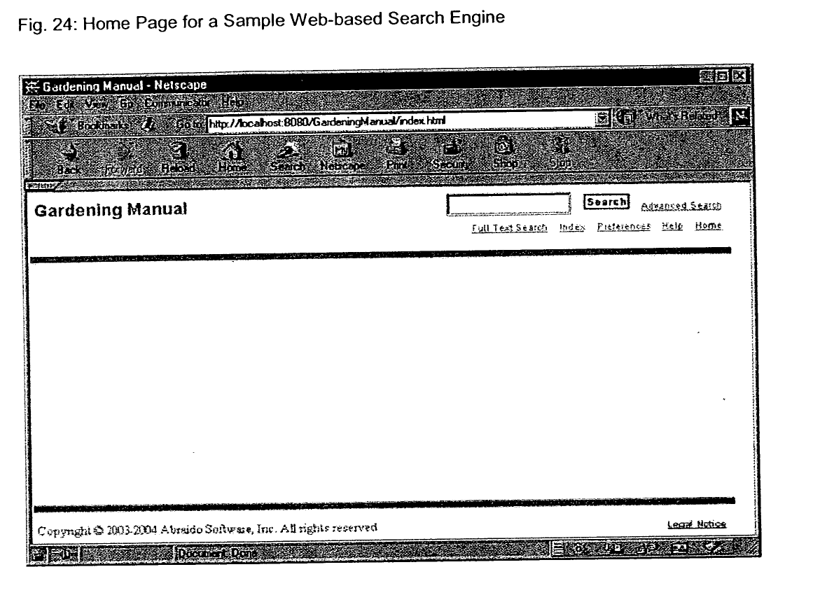

The generated XML files are used to create both Web-based and other versions of the search engine. In Web-based search engines, the XML files contain information for Web pages. In other versions, they contain information for the search engine's GUI. In the rest of this section, we use page to refer to both kinds of information. To illustrate the points, we use the GUI of the gardening manual search engine that we're building, which is shown in FIGS. 24-27, 29-34, and 36. However, we omit details on how the XML is transformed to the sample GUI, since we cover these details in the Search Engine Installer section.

The first XML file, Navigation Elements of FIG. 5, contains the navigation elements that, for ease of use, will typically be available from all pages in a Web-based version of the search engine, or as menu items in other kinds of search engines. These navigation elements are input boxes for searching by primary key value, a button to start the search, an advanced search feature, an index feature, a full text search feature, a preferences feature, a help feature, a home page feature, and a legal notice feature. This file also stores a copyright notice. FIGS. 24-27, 29-34, and 36 contain the screen shots for the English version of the Web-based search engine that we are building for the gardening manual. These screen shots illustrate how the navigation elements may appear in a Web-based search engine created with Search Engine Generator.

The XML schema language used for Navigation Elements defines XML elements to hold all the items described above. In the file's searchEngine element, GUI Generator sets the value of the attribute that stores the name of the search engine servlet or main program that processes the search by primary key. It also stores the action that the servlet or main program must perform: <searchEngine title=“ . . . ” servlet=“SearchEngine” actionID=“primaryKeySearch”>. We use an ellipsis for the search engine title since it depends on the natural language used for the file's contents; the actual titles are shown in Paragraph [00129]. The XML schema language also defines an attribute to store the page's title in the natural language used for the file's contents; the title comes from Resource Bundle. They're given below for our gardening manual example, where the ellipsis refers to the other page attributes noted in Paragraph [00128].

| | |
|---|---|
| <page ... title=“Navigation Elements”> | <!-- in English --> |
| <page ... title=“Elementos de Navegación”> | <!-- in Spanish --> |

For the “search by primary key” feature, there is one input box for each column in the primary key, as specified in Column Headings. The XML element that defines each input box uses the corresponding column name as the input box's name. This element has attributes to store the column heading in the natural language used for the file's contents, as well as the format for numbers, currencies, percents, dates, times, timestamps, and Boolean values in that language; the column headings and formats come from Column Headings. In our gardening manual example, the primary key is formed by only one column, plantName, so the XML defines only one input box to search by primary key. Since plantName is a string, there is no format information associated with it in Column Headings; its corresponding XML attribute has no value.

```
<!-- In the XML file containing the English GUI -->
<primaryKey>
  <column name=“plantName” heading=“Plant Name” format=“” />
</primaryKey>
<!-- In the XML file containing the Spanish GUI -->
<primaryKey>
  <column
    name=“plantName”
    heading=“Nombre de la Planta”
    format=“” />
</primaryKey>
```

These XML data are used to create the input box for primary key search shown in the sample search engine of FIGS. 24-27, 29-34, and 36. In this search engine's GUI, the column heading isn't used to label the input box for searching by primary key.

The XML element that specifies the image to use as a search button has an attribute to store the full path name of the file containing the image for use with the natural language in which the file's contents are written; GUI Generator gets this value from the eighth parameter within GUI Configuration, as explained in Paragraph [00119]. The element also defines an attribute for the alternate display of the search image; its value is expressed in the natural language used for the file's contents. This alternate name is defined within Resource Bundle. For the gardening manual, the XML appears below.

```
<!-- In the XML file for the English GUI -->
<button
  name=“search”
  path=“C:\GardeningManual\en\images\Search.gif”
  alternate=“Search” />
<!-- In the XML file for the Spanish GUI -->
<button
  name=“search”
  path=“C:\GardeningManual\es\images\Buscar.gif”
  alternate=“Buscar” />
```

The copyright notice corresponding to the content that Search Engine Generator provides also comes from Resource Bundle. The user supplies the copyright notice for the source document's content via GUI Configuration's ninth parameter. The gardening manual's copyright notices are represented as follows in XML.

```
<!-- In the XML file for the English GUI -->
<copyright
  src=“Search Engine Generator”
  value=“Copyright © 2003-2004 Abraído Software, Inc. All rights
reserved.” />
<copyright
  src=“source document”
  value=“Copyright © 2003-2004 Abraído Software, Inc. All rights
reserved.” />
<!-- In the XML file for the Spanish GUI -->
<copyright
  src=“Search Engine Generator”
  value=“ © 2003-2004 Abraído Software, Inc. Todos los derechos
reservados.” />
<copyright
  src=“source document”
  value=“ © 2003-2004 Abraído Software, Inc. Todos los derechos
reservados.” />
```

The sample search engine in FIGS. 24-27, 29-34, and 36 has only one copyright notice because Search Engine Generator's copyright notice is identical to the user-supplied one for this example.

The XML elements for specifying the advanced search, index, preferences, help, home, and legal notice features all store the name of the XML file containing the data to display when the feature is selected. For full text search, the XML element stores the name of the file containing the source electronic document; if there is more than one such file, it stores the name of an XML file containing links to each source electronic document file. Note that the user supplies the legal notice files, as described in Paragraph [00120], and the source electronic document files, as described in Paragraph [00118]; the rest are automatically generated with file names stored in Resource Bundle, as explained below. All these XML elements for feature storage contain an attribute for the text to use for each feature, in the natural language used for the file's contents; the values come from Resource Bundle. For the gardening manual search engine that we're creating, the XML looks like the following.

```
<!-- In the XML file containing the English GUI -->
<link
  name=“advancedSearch”
  fileName=“AdvancedSearch.xml”
  label=“Advanced Search” />
<!-- In the XML file containing the Spanish GUI -->
<link
  name=“advancedSearch”
  fileName=“BuscarAvanzada.xml”
  label=“Búsqueda Avanzada” />
<!-- Other links' XML is similar, except for the value of the
indicated attributes.
Index link:
name=“index”
fileName=“Index.xml” in English, and “Indice.xml” in Spanish
label=“Index” in English, and “Indice” in Spanish
Preferences link:
name=“preferences”
fileName=“Preferences.xml” in English, and “Preferencias.xml” in
Spanish
label=“Preferences” in English, and “Preferencias” in Spanish
Help link:
name=“help”
fileName=“Help.xml” in English, and “Ayuda.xml” in Spanish
label=“Help” in English, and “Ayuda” in Spanish
Home link:
name=“home”
fileName=“Home.xml” in English, and “Portada.xml” in Spanish
label=“Home” in English, and “Portada” in Spanish
Legal Notice link:
name=“legalNotice”
fileName=“C:\GardeningManual\en\LegalNotice.html” in English, and
“C:\GardeningManual\es\AvisoLegal.html” in Spanish
label=“Legal Notice” in English, and “Aviso Legal” in Spanish
Full Text Search link:
name=“fullTextSearch”
fileName=“FullTextSearch.xml” in English, and “BuscarDocumento.xml”
in Spanish
label=“Full Text Search” in English, and “Búsqueda en el Documento”
in Spanish
-->
```

The sample search engine in FIGS. 24-27, 29-34, and 36 show how these XML data in English may be used within the search engine.

The second XML file, Home of FIG. 5, contains the information to display in the search engine's home page. It provides an element to store the search engine's title, as noted in Paragraph [00129]. This information comes from GUI Configuration's eighth parameter. FIG. 24 shows how the search engine's title can be used within the English version of the search engine's home page.

The home page's XML schema language also defines an attribute to store the page's title in the natural language used for the file's contents; the title comes from Resource Bundle. They're given below for our gardening manual example, where the ellipsis refer to the other page attributes shown in Paragraph [00128]. This page title isn't used in the sample search engine home page shown in FIG. 24.

| | |
|---|---|
| <page ... title=“Home”> | <!-- in English --> |
| <page ... title=“Portada”> | <!-- in Spanish --> |

The third XML file, Advanced Search of FIG. 5, contains the information for the advanced search page. In the search engine element, GUI Generator stores the name of the search engine servlet or main program that executes the advanced search, as well as the action it must perform when called: <searchEngine title=“ . . . ” servlet=“SearchEngine” actionID=“advancedSearch”>. We use an ellipsis for the search engine title since it depends on the natural language used for the file's contents; the actual titles are shown in Paragraph [00129]. This XML file's schema language defines an attribute for the page's title in the natural language used for the file's contents; this title comes from Resource Bundle. For the gardening manual's advanced search page, these XML elements have the following values, where the ellipsis refer to the other page attributes described in Paragraph

| | |
|---|---|
| <page ... title=“Advanced Search”> | <!-- in English --> |
| <page ... title=“Busqueda Avanzada”> | <!-- in Spanish --> |

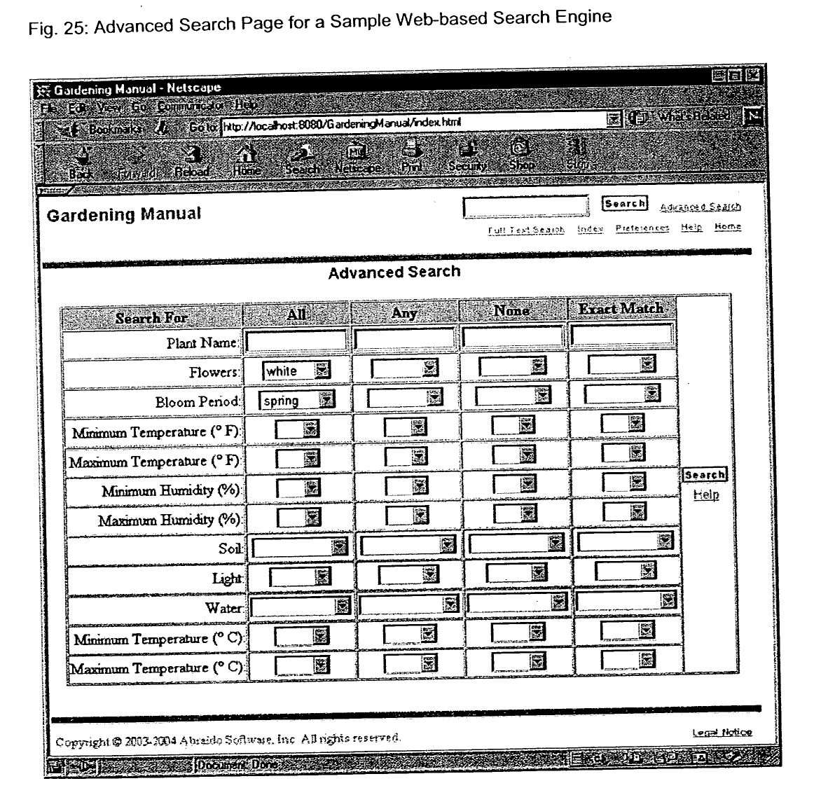

FIG. 25 shows the Advanced Search page in English for the sample search engine we're creating; we see how the page's title may be used in the page.

For each column in Column Headings, the XML schema language used for the advanced search page defines an element to store the column's name as well as an attribute to store the column's heading in the natural language used for the file's contents. For numbers, currencies, percents, dates, times, timestamps, and Boolean values, there is an attribute to store the display format for use with the natural language; these formats are empty for data that are strings. The Search For column of FIG. 25 shows how the values of the attributes storing the column headings in English may be used within the search engine; these are the same values entered in FIG. 17, which also shows the values of the XML attributes storing the format to use in English for the temperature and humidity data. FIG. 18 shows the corresponding XML attribute values for use in the Spanish version of the search engine's GUI. Both FIGS. 17 and 18 show the column names that will be stored in the advanced search page's XML, which appears below.

```
<!-- In the XML file containing the English GUI -->
<column
    name=“plantName”
    heading=“Plant Name”
    format=“” />
<!--
For brevity, we omit the XML of the flowerColor, bloomPeriod, soil,
light, and water columns because it's similar to that of plantName,
except for the column headings' value; these values are the
corresponding ones in Figure 17.
-->
<column
    name=“minTemp”
    heading=“Minimum Temperature (° F.)”
    format=“−1,234” />
<!--
For brevity, we omit the XML of the maxTemp, minHumidity, and
maxHumidity columns because it's similar to that of minTemp, except
for the column headings' value; these values are the corresponding
ones in Figure 17.
-->
<column
    name=“minTempCelsius”
    heading=“Minimum Temperature (° C.)”
    format=“−1,234.56” />
<!--
For brevity, we omit the XML of the maxTempCelsius column because
it's similar to that of minTempCelsius, except for the column
heading's value; this value is the corresponding one in Figure 17.
-->
<!--
The following are in the XML file containing the Spanish GUI. For
brevity, we show only the elements corresponding to the ones we
showed in the English version of the GUI. The rest are similar
except for the column headings' value. Figure 18 has the headings
for the elements that aren't shown.
-->
<column
    name=“plantName”
    heading=“Nombre de la Planta”
    format=“” />
<column
    name=“minTemp”
    heading=“Temperatura Minima (° F.)”
    format=“−1,234” />
<column
    name=“minTempCelsius”
    heading=“Temperatura Minima (° C.)”
    format=“−1,234.56” />
```

In this page's XML file, there's also an element to specify all possible values for each column, unless there are more values than the user-specified maximum provided via GUI Configuration; see Paragraph [00113]. The element's attributes store the column name and natural language used within the database, which is the same one in which the source document is written. (Recall that Column Headings stores the natural language in which the source document is written. GUI Generator saves this value so that it can be used to calculate the contents of the index page; it can then update the contents of Column Headings with the values entered in the sixth GUI Configuration parameter, as described in Paragraphs [00116]-[00117].) Subelements store each possible value. This information will be used to create a drop-down list within the GUI so the user can easily select the desired value during a search. GUI Generator finds each column's unique values by using JDBC with the information in Search Configuration to connect to the database, shown as Database in FIG. 5, and execute a SQL select distinct query.

For example, FIG. 25 shows white as a possible value for the flower color. This means the advanced search page's XML file contains an element for the flowerColor column, which would be similar to the one below.

```
<allChoices column=“flowerColor” language=“English”>
    <choice value=“white” />
    <choice value=“yellow” />
    <!-- And similar choice elements for other colors. -->
</allChoices>
```

Its subelements include one for white. GUI Generator found all possible flower colors in the database by executing this SQL query: select distinct flowerColor from Plants. There were 10 or fewer results for this query. Note that the Spanish version of the advanced search page's XML file will contain the exact same values within its allChoices element. Since the source document is written in English, the information in the database is also in English.

The XML schema language used for the advanced search page also defines an element to specify the file name of the image to use for the search button and its alternate name. The values used for this search button element and its attributes are identical to those used for the corresponding element in search by primary key, as mentioned in Paragraph

The XML schema language used for the advanced search page also defines an element for specifying a help feature. It stores the file name of the XML file to display when the help feature is selected. This element contains an attribute for the text to use for the help link or menu item, in the natural language used for the file's contents. The values for this help element and its attributes are identical to those used for the help feature in Navigation Elements, whose help feature is described in Paragraph [00136]. The only difference is that the file name includes the anchor name of the section of the help file corresponding to the advanced search page; this anchor is stored in Resource Bundle, and is described in Paragraphs [00160]-[00161]. In other words, the help link is defined as follows within the XML for the advanced search page.

```
<!-- In the XML file containing the English GUI -->
<link
    name=“help”
    fileName=“Help.xml#advancedSearch”
    label=“Help” />
<!-- In the XML file containing the Spanish GUI -->
<link
    name=“help”
    fileName=“Ayuda.xml#buscarAvanzada”
    label=“Ayuda” />
```

The fourth XML file, Index of FIG. 5, has the contents of the index page. Its XML schema language defines an element for the page's title, including an attribute to store the title in the natural language used for the file's contents; this title comes from Resource Bundle. The XML for the title of the gardening manual's index page follows, where the ellipsis refers to the other page attributes described in Paragraph [00128].

| | |
|---|---|
| <page ... title=“Index”> | <!-- in English --> |
| <page ... title=“Indice”> | <!-- in Spanish --> |

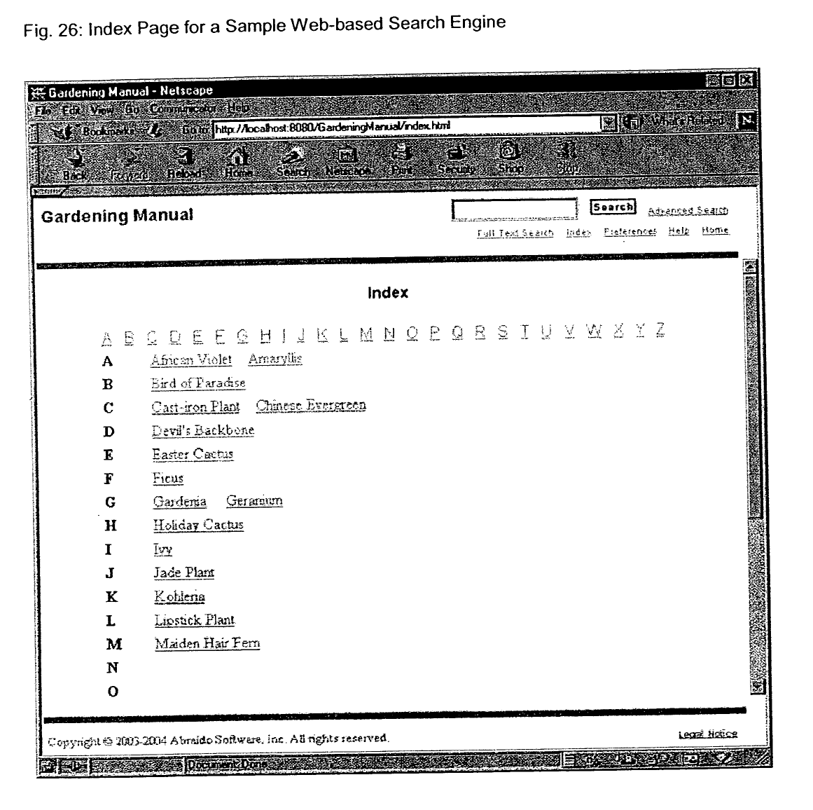

The title's use within the English version of the search engine is illustrated in our sample search engine's index page of FIG. 26.

This XML file also defines an element for denoting a letter in the alphabet of a natural language. The letter element's subelements store a pair, where each pair consists of the value of an index entry that begins with that letter and the way to invoke the search engine servlet or main program to retrieve the record whose primary key has that value. The XML file containing the index page has one such letter element for each letter in the default natural language in which the source document is written. The set of letters for each supported natural language are defined in Resource Bundle. For the gardening manual's index page of FIG. 26, this XML would be as follows.

```
<letter language=“English” name=“A”>
  <entry
    label=“African Violet”
    servlet=
    “/SearchEngine?actionID=primaryKeySearch&plantName=
    African+Violet” />
  <entry
    label=“Amaryllis”
    servlet=
    “/SearchEngine?actionID=primaryKeySearch&plantName=
    Amaryllis” />
</letter>
<letter language=“English” name=“B”>
  <entry
      label=“Bird of Paradise”
      servlet=
  “/SearchEngine?actionID=primaryKeySearch&plantName=
  Bird+of+Paradise” />
</letter>
<!-- And similar elements for other letters and index entries. -->
```

FIG. 26 shows how this XML information may be used within a search engine. It shows the letters of the English alphabet since the gardening manual is written in English. If our sample source document were written in Spanish, its search engine's index page would have a similar list of letters, but it would also include CH after C, LL after L, N after N, and RR after R. Note that the index page always uses the alphabet of the natural language in which the source document is written, even though the rest of the GUI may be written in another natural language. This is necessary since the database entries are expressed in the source document's natural language.

To calculate which index entries begin with each letter, GUI Generator uses JDBC with the information in Search Configuration to connect to the database. GUI Generator determines which columns form the primary key by looking this up in Column Headings. It then executes a SQL select query to retrieve the primary key value for all records, and asks SQL to sort the results by primary key. By examining the first letter of each result, GUI Generator can determine to which letter in the index page to assign the entry.

For our gardening manual, the primary key is plantName, so GUI Generator connects to the database and executes this SQL query: select plantName from Plants order by plantName. The matching records include African Violet, Amaryllis, Bird of Paradise, Cast-iron Plant, Chinese Evergreen, and the other plants appearing in FIG. 26. Since African Violet and Amaryllis both begin with the letter A, GUI Generator adds them as subelements of the letter A in the index page's XML file. The search engine servlet or main program invocation stored in the XML with the Amaryllis entry is a string of the form “/SearchEngine?actionID=primaryKeySearch&plantName=Amaryllis”. The /SearchEngine?actionID=primaryKeySearch refers to the way to invoke the search engine servlet or main program in order to have it execute a search by primary key, and the plantName=Amaryllis portion is the primary key column name and value for the SQL select statement's where clause. In other words, this invocation would cause the search engine to execute the following SQL statement when the user clicks the Amaryllis link in the index page shown in FIG. 26: select desiredColumns from Plants where plantName=Amaryllis order by sortColumns. The desiredColumns and sortColumns values come from the user's preferences for the columns to include in the search results and the columns to use to sort the results, as described in the Preferences section. The Plants table name comes from Search Configuration, as noted in Paragraph [00226].

The fifth XML file, Preferences of FIG. 5, has the contents of the page for specifying the user's search preferences. GUI Generator sets this file's searchEngine servlet attribute to the search engine servlet or main program invocation for processing the user's preferences: <searchEngine title=“ . . . ” servlet=“SearchEngine” actionID=“setPreferences”>. We use an ellipsis for the search engine title since it depends on the natural language used for the file's contents; the actual titles are shown in Paragraph [00129]. Its XML schema language defines an element for the page's title, including an attribute to store the title in the natural language used for the file's contents. The value for this attribute comes from Resource Bundle. This part of the XML file is shown below, where the ellipsis refer to the other page attributes described in Paragraph [00128].

| | |
|---|---|
| <page ... title=“Preferences”> | <!-- in English --> |
| <page ... title=“Preferencias”> | <!-- in Spanish --> |

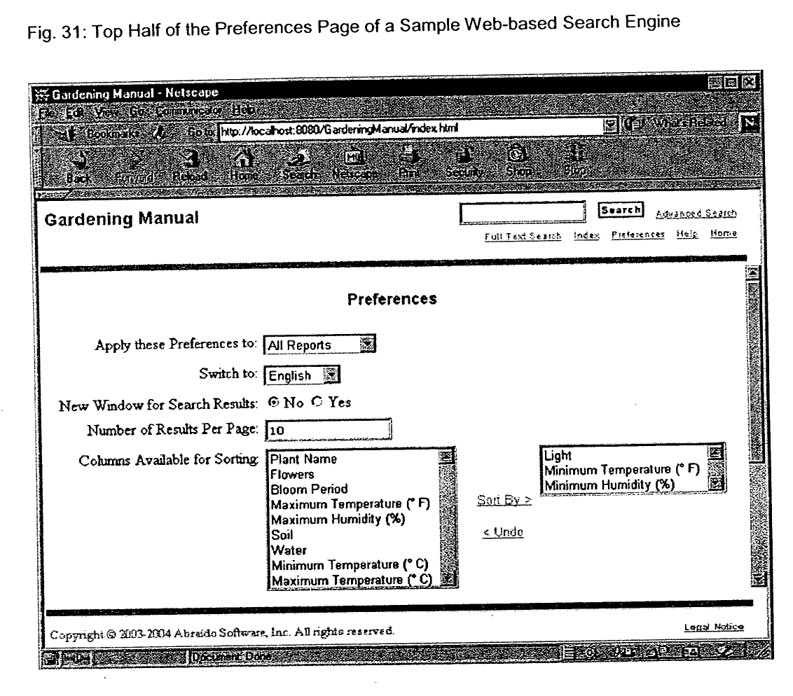

FIG. 31 shows the top of the preferences page of the gardening manual's search engine in English, which includes the page's title.

In addition, the preferences page's XML schema language defines elements for storing (1) whether the preferences apply to the current report, or all reports; (2) which natural language to use for the GUI, if all are accessible from the same search engine as noted in Paragraph [00115]; (3) if the results should appear in a new window, or the current one; (4) the number of results to display per page; (5) which columns should be used by default to order the results; and (6) which columns should be included by default in the table displaying the results. These six preferences elements have an attribute for the name of the GUI control. Another attribute stores its label in the natural language used for the file's contents. A third attribute stores its default value in the natural language. In the case of the column to use for sorting the results, the columns that should appear in the report, the natural language to use for the display, and the scope of the preferences, the preference's element has an attribute stating whether or not multiple selections are allowed. Another set of subelements store the possible values from which to choose.

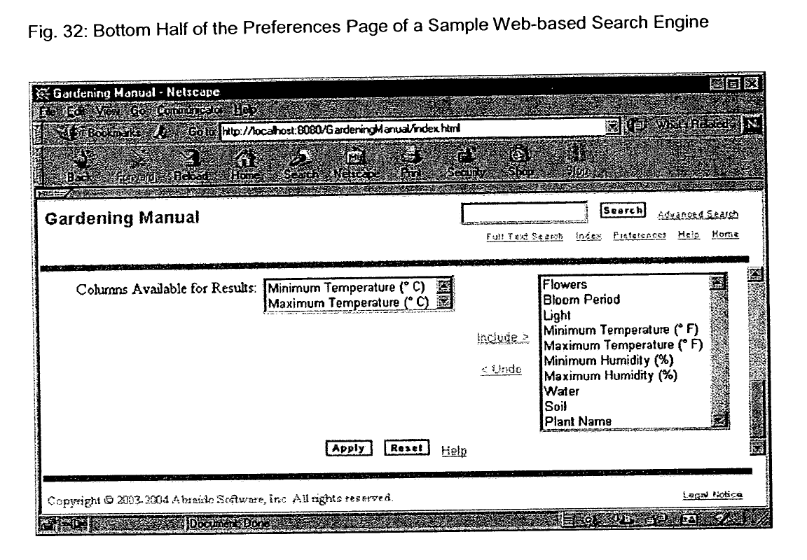

To illustrate these points, we'll use the data in the preferences page of FIGS. 31-32. FIG. 31 contains a control for selecting whether the preferences apply to all reports or just the current one. The preferences page's XML file contains an element that defines this control's data.

```
<!-- In the XML file containing the English GUI -->
<prefScope
    guiControlName=“scope”
    allowMultipleSelections=“false”
    label=“Apply these Preferences to”>
    <prefScope_choice value=“All Reports” />
    <prefScope_choice value=“Current Report” />
    <prefScope_default value=“All Reports” />
</prefScope>
<!-- In the XML file containing the Spanish GUI -->
<prefScope
    guiControlName=“scope”
    allowMultipleSelections=“false”
    label=“Aplicar las Preferencias a”>
    <prefScope_choice value=“Todos los Informes” />
    <prefScope_choice value=“Informe Actual” />
    <prefScope_default value=“Todos los Informes” />
</prefScope>
```

Within the search engine's source code, this GUI control will be referred to as scope; GUI Generator provides this name. The user may select only one value from its drop-down list, since multiple selections are not allowed; again, GUI Generator provides this value. In the English version of the search engine's GUI, this control will be labeled as Apply these Preferences to, as shown in FIG. 31. In the Spanish GUI, though, it's labeled as Aplicar las Preferencias a; this label's values come from Resource Bundle. In the English GUI, the control's drop-down list has the values All Reports and Current Report, while the Spanish GUI provides Todos los Informes and Informe Actual as these values; they all come from Resource Bundle. In the English GUI, the default value for this control is All Reports, as shown in FIG. 31, while Todos los Informes is its default value in Spanish. GUI Generator determines the default values, but uses their labels as defined in Resource Bundle.

The XML for the language to use within the GUI is similar; multiple selections are not allowed here, either. But the values for its drop-down list come from GUI Configuration's fourth parameter, with values in other natural languages coming from Resource Bundle. In our example of the gardening manual, the drop-down list includes only English and Spanish in the English GUI shown in FIG. 31, with inglés and español as the values to use in Spanish. GUI Generator selects the default value to be the natural language in which the source document is written. FIG. 31 shows it as English.

The XML for whether or not the search results should appear in a new window also resembles that for the scope of the preferences. However, there's no attribute for multiple selections, since this control won't be modeled as a drop-down list. It appears as radio buttons in FIG. 31, with No and Yes values.

The XML for the control that determines the number of results to include per page is similar to the scope's XML, except that there's no attribute for multiple selections or a list of choices. GUI Generator supplies its default value. In our gardening manual example, its default value is 10, as shown in FIG. 31.

The XML for the columns to use for sorting, and for inclusion in the report, is very similar to that for the scope of the preferences. In these cases, though, multiple selections are allowed from the drop-down lists. GUI Generator gets the values to include in the drop-down lists from Column Headings, and GUI Generator provides their default values. The primary key's columns are the default columns to use for sorting, and all columns are included by default in the report. The example in FIGS. 31 and 32 show that the user has made some changes to these defaults, since Plant Name is not the column to use for sorting, and since the temperatures in degrees Celsius will not be included in the report.

The XML schema language used for the preferences page also defines elements corresponding to buttons that apply the preferences or reset the form. These elements' attributes contain the full path name to the files containing the buttons' image in the natural language used for the file's contents, and its alternate label in that natural language. The following XML shows the values for our gardening manual example.

```
<!-- In the XML file for the English GUI -->
<button
    name=“apply”
    path=“C:\GardeningManual\en\images\Apply.gif”
    alternate=“Apply” />
<button
    name=“reset”
    path=“C:\GardeningManual\en\images\Reset.gif”
    alternate=“Reset” />
<!-- In the XML file for the Spanish GUI -->
<button
    name=“apply”
    path=“C:\GardeningManual\es\images\Aplicar.gif”
    alternate=“Aplicar” />
<button
    name=“reset”
    path=“C:\GardeningManual\es\images\Restablecer.gif”
    alternate=“Restablecer” />
```

GUI Generator supplies the value to use for the buttons' name attribute. The value of the path attribute comes from GUI Configuration's eighth configuration parameter, while the value for its alternate attribute comes from Resource Bundle. FIG. 32 shows how these buttons appear in the English version of the search engine's preferences page.

The XML for the preferences page also has an element for specifying a link to the help page or a help menu item. The name attribute stores this control's name; GUI Generator supplies its value. The label attribute defines the help link's or menu item's label in the natural language used for the file's contents; this label's value comes from Resource Bundle. The fileName attribute stores the help file's name; the help file is the same one noted in Paragraph [00136], but contains the name of the anchor for the preferences section of the help file, as described in Paragraphs [00160]-[00161]. The corresponding XML for our gardening manual example appears below. FIG. 32 shows how the help link appears in the sample search engine's English GUI.

```
<!-- In the XML file containing the English GUI -->
<link
    name=“help”
    fileName=“Help.xml#preferences”
    label=“Help” />
<!-- In the XML file containing the Spanish GUI -->
<link
    name=“help”
    fileName=“Ayuda.xml#preferencias”
    label=“Ayuda” />
```

The sixth XML file, Help of FIG. 5, has the contents of the help page, which explains how to use the search engine's features. This page's XML schema language defines an element for the page's title, including an attribute to store the title in the natural language used for the file's contents. Here's the corresponding XML for our gardening manual example, where the data for the title attributes comes from Resource Bundle. The ellipsis refer to the other page attributes described in Paragraph [00128].

<page ... title=“Help”> <!-- in English -->
<page, ... title=“Ayuda”> <!-- in Spanish -->

There is also an element to specify the table of contents in the natural language used for the file's contents. Our gardening manual's corresponding XML appears below; these elements come after the page element shown above. The data for the title and anchor attributes come from Resource Bundle. The anchor may be used to create links within the installed version of the help file, as described in the Search Engine Installer section. Note that the same table of contents is created for all search engines running in that language.

```
<!-- In the XML file containing the English GUI -->
<helpPage_TOC>
    <toc title=“Introduction” anchor=“intro” />
    <toc
        title=“Searching By Primary Key”
        anchor=“primaryKeySearch” />
    <toc title=“Advanced Search” anchor=“advancedSearch” />
    <toc title=“Search Results” anchor=“searchResults” />
    <toc title=“Search Errors” anchor=“searchErrors” />
    <toc title=“Full Text Search” anchor=“fullTextSearch” />
    <toc title=“Index” anchor=“docIndex” />
    <toc title=“Preferences” anchor=“preferences” />
    <toc title=“Help” anchor=“help” />
    <toc title=“Home” anchor=“home” />
    <toc title=“Legal Notice” anchor=“legalNotice” />
</helpPage_TOC>
<!-- In the XML file containing the Spanish GUI -->
<helpPage_TOC>
    <toc title=“Introduccíon” anchor=“intro” />
    <toc
        title=“Búsqueda por clave principal”
        anchor=“buscarClavePrincipal” />
    <toc
        title=“Búsqueda avanzada”
        anchor=“buscarAvanzada” />
    <toc
        title=“Resultados de la búsqueda”
        anchor=“resultados” />
    <toc title=“Errores” anchor=“errores” />
    <toc
        title=“Búsqueda en el documento”
        anchor=“buscarDocumento” />
    <toc title=“Indice” anchor=“indice” />
    <toc title=“Preferencias” anchor=“preferencias” />
    <toc title=“Ayuda” anchor=“ayuda” />
    <toc title=“Portada” anchor=“portada” />
    <toc title=“Aviso legal” anchor=“avisoLegal” />
</helpPage_TOC>
```

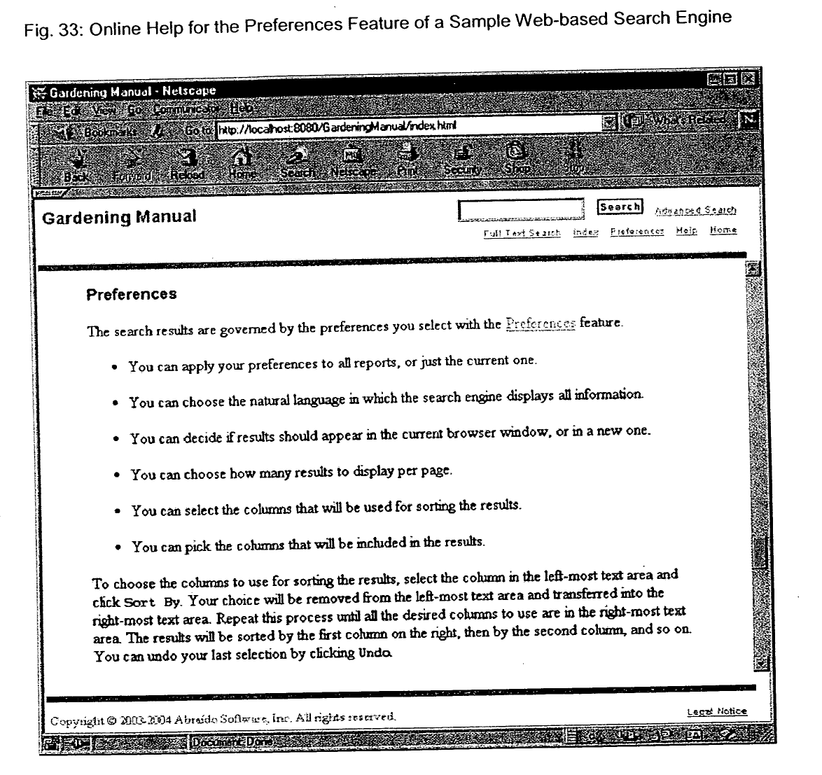

The XML for the help file also contains elements to specify (1) instructions for finding all records in the document; (2) instructions for finding all records whose primary key matches a given value; (3) instructions for the advanced search feature, i.e., how to find all records that match specific criteria, including how to specify different kinds of Boolean expressions; (4) a list containing each column heading from the database; (5) a note to the effect that all searches are case insensitive; (6) instructions for sorting the results by a different column, and for navigating between the various pages containing the search results; (7) a description of the information available in the index page, and how to navigate within the page; (8) instructions for accessing the full text of the electronic version of the source document; (9) descriptions of the various preferences that the user can change, as noted in Paragraphs [00151] to [00156]; and (10) instructions for returning to the home page or for viewing any legal notices related to the search engine. To illustrate, we show the XML element for the instructions on setting preferences. Note that the anchor attributes of the section elements have the same value as the anchor attributes in the corresponding toc elements. The anchors within the section elements are used to create HTML anchors within the help file, as explained in the Search Engine Installer section. FIG. 33 shows how these XML values appear within the preferences section of the search engine's help page in English.

```
<!-- In the XML file containing the English GUI -->
<section
    name=“preferences”
    title=“Preferences”
    anchor=“preferences”>
    <para>The search results are governed by the preferences you
select with the <link fileName=“Preferences.xml”>Preferences</link>
feature.
    </para>
    <!-- Additional paragraphs in English go here. -->
</section>
<!-- In the XML file containing the Spanish GUI -->
<section
    name=“preferences”
    title=“Preferencias”
    anchor=“preferencias”>
    <para>Los resultados de la búsqueda están gobernados por las
preferencias que Ud. elige con <link fileName=“Preferencias.xml”>
Preferencias</link>.
    </para>
    <!-- Additional paragraphs in Spanish go here. -->
</section>
```

The section element defines a section of the help file; the value for its name attribute comes from GUI Generator. The title attribute stores the section's title in the natural language used for the file's contents; this value comes from Resource Bundle. FIG. 33 shows how this title is used in an actual search engine help page running in English. The para elements denote paragraphs within each section. They can contain links to other documents, as shown in our example; the first paragraph in each language links to the search engine's preferences page. GUI Generator inserts the name of the XML file to which the link refers; Search Engine Installer converts it to the corresponding GUI file once the search engine is ready for installation. The value for these para elements come from Resource Bundle. Though not shown in our example, the para element may also contain elements that model text formatting information, such as bold or italicized text, or text that should be rendered in a monotype font to emphasize that it represents source code such as GUI controls. These para elements may also contain elements to denote numbered or unordered lists, as well as user-supplied documentation, as described next.

The help page's XML schema language also defines elements for user-supplied documentation, including examples and the document's author, title, publisher, and publication date. GUI Generator creates these elements without values, and the user may edit them. The source document element for the gardening manual appears below.

```
<!-- In the XML file containing the English GUI -->
<user_srcDoc
    author=“”
    title=“”
    publisher=“”
    publicationDate=“” />
<!-- The XML file in Spanish has an identical entry. -->
```

Note that GUI Generator doesn't create any user_example elements for user-supplied examples. The user may add these within any of the help file's section elements. Examples have a name attribute that can be used in source code. They have a title attribute to store the example's title in the natural language used for the file's contents. These user_example elements may contain para elements to define paragraphs, or link elements to define links to other sections of the help file. They may also contain numbered or unordered lists as well as any of the elements used for text formatting.

As noted earlier, the text to use within the help file, including its internationalized and localized variants, comes from Resource Bundle. The only exception is the list of column headings, which GUI Generator gets from Column Headings. Typically, the user will add documentation on what each column represents, and regenerate the help file with the Administrator component, as described in the Administrator section.

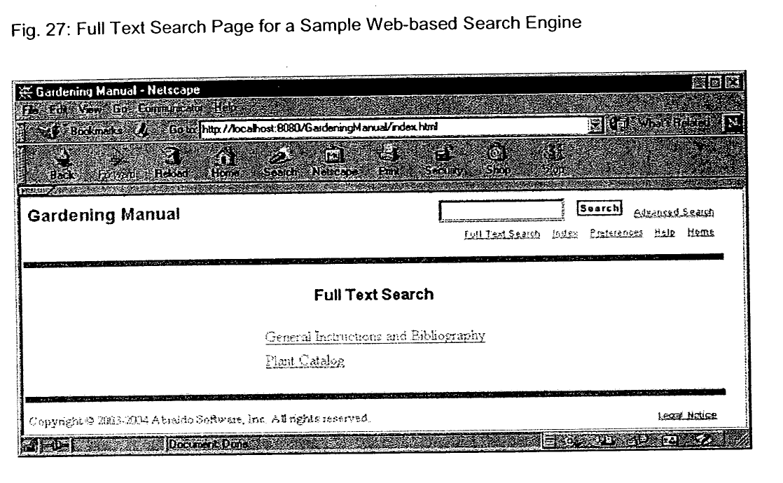

When the source electronic document consists of more than one file, GUI Generator creates a seventh XML file, Full Text Search of FIG. 5, to represent the page linked to during a full text search. Its XML schema language defines an attribute for the page's title in the natural language used for the file's contents; the title comes from Resource Bundle. It also defines elements to store the file name of each source document file and a description of its contents in the natural language used for the file's contents. The file names and descriptions come from Search Configuration, but only the file names—not the full path—are copied to the full text search page's XML file. These elements' values are shown below for our gardening manual, where the ellipsis refer to the other page attributes described in Paragraph [00128]. FIG. 27 shows how the values from this XML file may be used in the search engine's full text search page written in English.

```
<!-- In the XML file containing the English GUI -->
<page ... title=“Full Text Search”>
    <srcDocFile
        fileName=“GeneralInfo.doc”
        description=“General Instructions and Bibliography” />
    <srcDocFile
        fileName=“PlantCatalog.doc”
        description=“Plant Catalog” />
</page>
<!-- In the XML file containing the Spanish GUI -->
<page ... title=“Búsqueda en el Documento”>
    <srcDocFile
        fiieName=“GeneralInfo.doc”
        descriptiom=“Instrucciones Generales y Bibliografía” />
    <srcDocFile
        fileName=“PlantCatalog.doc”
        description=“Catálago de Plantas” />
</page>
```

The end result is the component labeled Search Engine GUI in FIG. 5, a set of XML files in the directory noted in Paragraph [00122] that specify the various components of the search engine's graphical user interface.

### Search Engine Installer

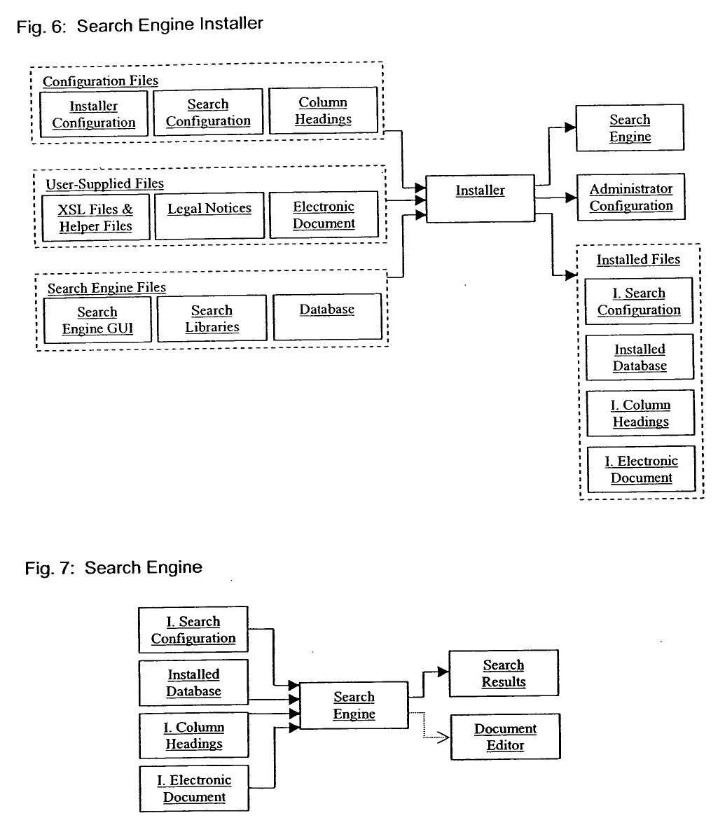

FIG. 6 shows the inputs to, and outputs from, the Search Engine Installer component. It is responsible for installing Search Engine on a target platform. Installer has three kinds of inputs. Configuration Files in FIG. 6 represent the various configuration files Installer needs, User-Supplied Files are the information the user provides, and Search Engine Files are the automatically generated and standard library files. If changes are needed, Installer copies these input files and modifies the copies instead of the originals. This allows reusing the original files for additional versions of the search engine.

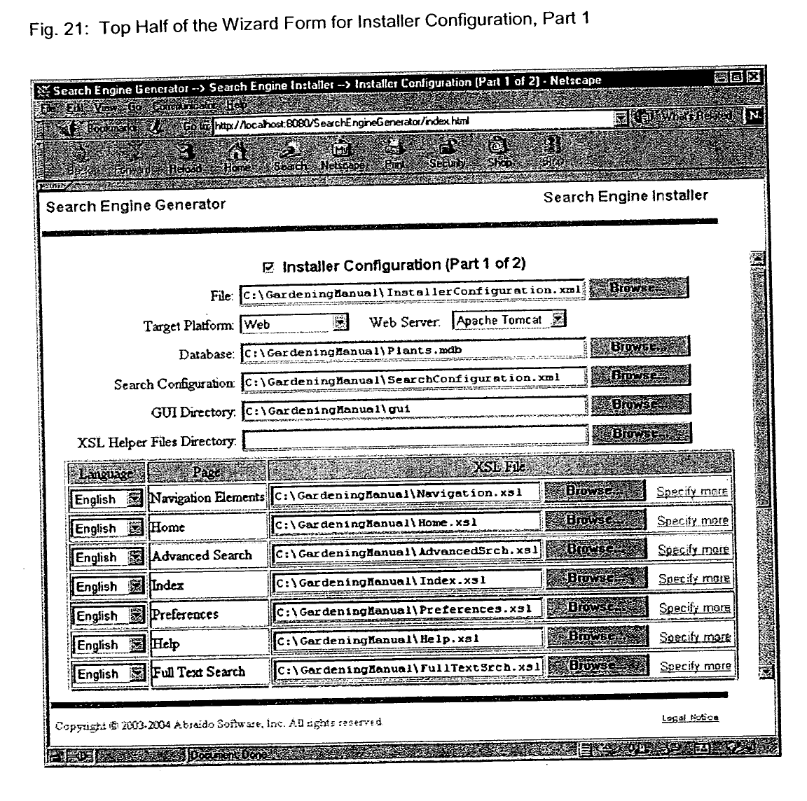

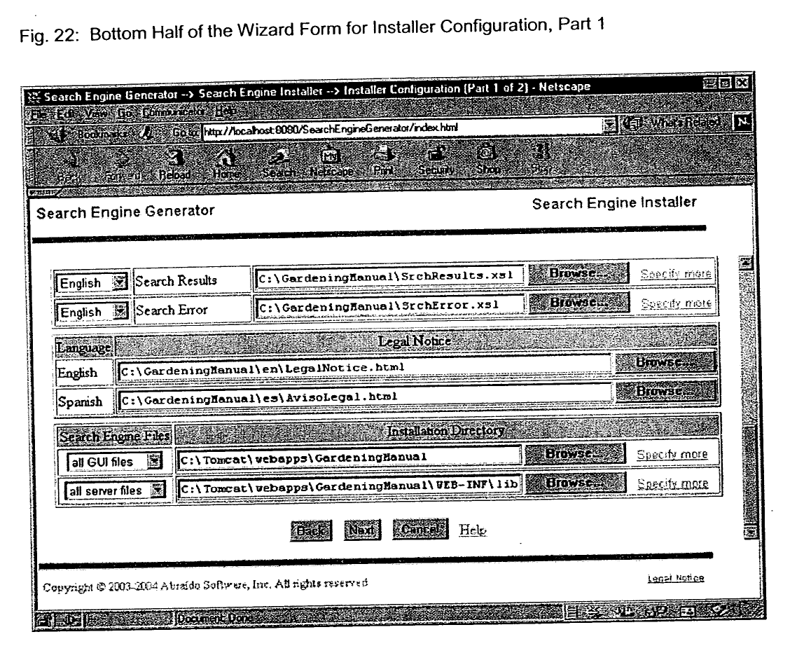

Note that Database Generator of FIG. 4 created the component labeled Database in FIG. 6. GUI Generator of FIG. 5 created Search Engine GUI of FIG. 6 and also updated the components labeled Column Headings and Search Configuration. Installer Configuration is an XML file in which Search Engine Generator's user specifies values for the parameters that control the search engine installation process. He enters these fifteen parameters with the Search Engine Generator wizard shown in FIGS. 21-23. Since five of these parameters depend on the value entered for another parameter, the wizard presents the user with two forms to fill out. In the first form, shown in FIGS. 21-22, the user enters the first nine configuration parameters; the servlet uses the value of one of these to fill out the second form, shown in FIG. 23, where the user can change the value of the last six parameters. All fifteen parameters are described below.

The first parameter is the type of system on which to install the search engine, and is the Target Platform field in FIG. 21. It can either be the Web, a network of computers, a standalone computer, or a PDA, though additional platforms can be included using the same approach. For Web applications, the user must choose the target Web server from a list of supported Web servers; this is the Web Server field of FIG. 21.

The second parameter is the full path name to the database that Database Generator created, shown as Database in FIG. 6. It is the Database field in FIG. 21.

The third parameter is the full path name to Search Configuration, and is represented by the Search Configuration field in FIG. 21. It's the same value noted in Paragraph [00112]. The wizard copies its value from GUI Configuration.

The fourth parameter is the full path name of the directory where the GUI files were created. This is the same item noted in Paragraph [00122], and is automatically copied by the wizard into the GUI Directory field of FIG. 21.

The fifth parameter is a list of full path names to the XSL files used to translate the GUI's XML files to HTML, if a Web-based version of the search engine is desired. Since there can be six to seven such XML files, as noted in Paragraph [00126], the list contains eight to nine elements, one for each XML file plus two more for the search results and search error pages that the automatically generated search engine creates. (The search results and search error pages are described below in the section titled Search Engine.)

The fifth parameter's user interface is shown in FIG. 21's table, which is continued at the top of FIG. 22. For each page, the user clicks the row's Browse button to select the desired XSL file to use for the GUI in the indicated natural language. The example in FIGS. 21-22 shows the files to use for the English GUI, so the user must still enter the information for the Spanish version of the GUI. Since different natural languages may require different data displays, the user may click the Specify more link to create an additional row in the table containing the same page; he can then change the natural language in the new row and specify the XSL file to use for the page in that language. In the corresponding XML, elements denoting each GUI file store the name of the XSL file to use to transform the XML to HTML in a selected natural language. An attribute denoting the default stores the XSL to use for any natural language that is not specifically mentioned, but for which the user wants to generate a translation.

To illustrate, suppose the Search Engine Generator user wants to provide Arabic, Chinese, English, and Spanish versions of the search engine for his source document. He would have entered these as a parameter within GUI Configuration, as noted in Paragraph [00114]. Since Arabic is read right to left and top to bottom, Chinese is read top to bottom and right to left, and English and Spanish are both read left to right and top to bottom, three different XSL stylesheets may be used to translate the XML to HTML. Within Installer Configuration's wizard, the user would select Arabic as the language and then he'd enter the page's XSL for use with Arabic. Afterwards, he'd click Specify more to create a new row for the same page, and follow the same procedure to specify the XSL to use with Chinese. For the XSL to use for English and Spanish, he'd again click Specify more, but this time he'd choose default as the language in that row before entering the XSL's full path name. The resulting XML would be similar to the following. For brevity, we show only the entry for the XML file containing the advanced search page, but there would be similar entries for the navigation elements, home, index, preferences, help, full text search, search results, and search error pages.

```
<guiFile name=“AdvancedSearch.xml”>
    <guiFile_xsl
        language=“Arabic”
        fileName= “C:\myApp\ar\AdvancedSearch.xsl” />
    <guiFile_xsl
        language=“Chinese”
        fileName=“C:\myApp\zh\AdvancedSearch.xsl” />
    <guiFile_xsl
        language=“default”
        fileName=“C:\myApp\AdvancedSearch.xsl” />
</guiFile>
```

Since neither English nor Spanish were specifically mentioned, the XSL marked as the default will be used to translate the XML to HTML for English and Spanish versions.

Note that Installer provides default XSL stylesheets if the user doesn't specify any. The user's own stylesheets should be based on the default ones, which indicate how the XML elements and attributes are translated to HTML that correctly invokes the search engine servlet. To prevent problems when executing the search engine, users should therefore limit their stylesheet changes to text formatting, page layout, similar appearance issues, or updates to directory names as described in Paragraph [00180]. In non-Web search engines, the search results are automatically generated in a format that can be displayed in the target platform's graphical user interface.

The sixth parameter is the full path name to the directory containing the files referred to by the user's XSL files, if they were supplied. For example, these may include HTML, JSP, CSS, JavaScript, JScript, ECMAScript, or image files such as GIF or JPEG. This parameter appears as the XSL Helper Files Directory in FIG. 21.

The seventh parameter is the full path name of the user-supplied files containing the legal notices that apply to the search engine. It's the same item noted in Paragraph [00120]; the wizard copies this value into FIG. 22's table containing Language and Legal Notice columns.

The eighth parameter is a list containing the full path name to the directory or directories in which to install Search Engine's GUI files as well as the source document's files. Since the GUI may consist of HTML, JSP, CSS, JavaScript, JScript, ECMAScript, XML, XSL, and image files, there are nine possible file types plus a tenth file type for the source document; so the parameter may have up to ten elements to correspond to each file type. Thus, each type of file may be installed in a different directory, if desired. If different directories are used, they will typically be subdirectories of the one in which the HTML or XML files are installed. This parameter's user interface is in the first row of FIG. 22's table headed with Search Engine Files and Installation Directory. The drop-down list can be used to select the type of file, and the Specify more link can be used to add more rows to the table to specify additional directories for different kinds of GUI files.

Note that the default XSL stylesheets assume that all the GUI's files are in the same directory, with the files for a given natural language stored within a subdirectory whose name is the ISO 639 code for the language's name. For example, English files are assumed to be in the en subdirectory, while Spanish files are assumed to be in the es subdirectory. For the installation shown in FIG. 22, Installer places the English version of the GUI in C:\Tomcat\webapps\GardeningManual\en while putting the Spanish version in C:\Tomcat\webapps\GardeningManual\es. It places the source document files in C:\Tomcat\webapps\GardeningManual. If the user specifies more than one directory for GUI file installation, Installer will update file names and full path names within the affected XML files so that the XSL stylesheets will still produce correct path names in the HTML files.

The ninth parameter is a list containing the full path name to the directory in which to install Search Engine's server files. These are Java jar files and the file containing the relational database. So there may be up to two elements in this list. This parameter's user interface is in the second row of FIG. 22's table headed with Search Engine Files and Installation Directory. The drop-down list can be used to select the type of file, and the Specify more link can be used to add more rows to the table to specify additional directories for different kinds of server files.

Once the user enters the first nine parameters and clicks the wizard's Next button, the servlet parses Search Configuration with a standard SAX parser and uses its values to fill in the default values for the next five installation parameters. These parameters control access to the installed relational database, as described below. The last parameter's value can also be entered in this form.

The tenth installation parameter is the JDBC driver to use to connect to the installed relational database. It's the JDBC Driver field in FIG. 23. Its value is the name of the JDBC driver's Java class.

The eleventh parameter is the location of the database server that will run the installed relational database; this parameter also includes the name of the relational database once it's installed. FIG. 23 shows it as Target Database. Note that its value is the string to pass to Java's java.sql.DriverManager.getConnection method to establish a connection with the database using the selected JDBC driver. In this example, the string includes the target relational database's DSN, which is PlantsDB. If they don't already exist, the person running Installer must create on the target platform any objects the JDBC driver requires to connect to the installed relational database. For example, he must create the PlantsDB DSN. It refers to the installed version of the relational database, the one that will be in C:\Tomcat\webapps\GardeningManual\WEB-INF\lib\Plants.mdb. The user creates these objects after installation finishes, but before running the search engine for the first time.

The twelfth parameter is the name of the user that should connect to the installed relational database. It's the user Name field of FIG. 23.

The thirteenth parameter is that user's password for the installed relational database. It's the Password field in FIG. 23.

The fourteenth parameter is the name of the table containing the data in the installed relational database. FIG. 23 shows it as Table Name.

The fifteenth and final parameter is the name to use for the file that will contain Administrator's configuration parameters, shown as Administrator Configuration in FIG. 6. The user enters this file name in the Administrator Configuration field of FIG. 23.

The main installer component, labeled Installer in FIG. 6, gets one input parameter; it was created with the Search Engine Generator wizard. This parameter is the object representing the information in the configuration file, Installer Configuration. Installer uses the directory stored in the parameter described in Paragraph [00172] to find the automatically generated XML files containing the GUI; these XML files are represented with the Search Engine GUI component of FIG. 6. If necessary, it copies the files to a temporary directory and modifies the copies by changing full path names within each XML file to path names that are relative to the installation directories given by the eighth and ninth installation parameters, as described in Paragraphs [00179] and [00181]. If necessary, it also changes the path name separator character to that required by the target Web server or HTML.

For example, within the XML files representing the navigation elements and advanced search pages, it updates the file names used for the search button after saving the full path to the button; it needs the full path name to locate the file and copy it to the installation directory. It makes similar changes to the apply and reset buttons within the preferences page's XML files.

```
<!-- In the XML file for the English GUI -->
<button
    name=“search”
    path=“Search.gif”
    alternate=“Search” />
<!-- In the XML file for the Spanish GUI -->
<button
    name=“search”
    path=“Buscar.gif”
    alternate=“Buscar” />
```

Note that all of the gardening manual's GUI files will be installed in C:\Tomcat\webapps\GardeningManual. To avoid confusion, though, Installer automatically creates an en subdirectory for the English version of the files, and an es subdirectory for the Spanish version of the files. These are standard ISO 639 codes for the representation of language names. In this example, Installer also copies to the corresponding subdirectory the files containing images. If the user had instead specified that images were to be placed in C:\Tomcat\webapps\GardeningManual\images, then Installer would place the English images in images\en\ and the Spanish images in images\es\. As a result, Installer would make the following changes to the navigation elements and advanced search pages' XML files, with similar changes to the apply and reset buttons within the preferences page's XML files.

```
<!-- In the XML file for the English GUI -->
<button
    name=“search”
    path=“images/en/Search.gif”
    alternate=“Search” />
<!-- In the XML file for the Spanish GUI -->
<button
    name=“search”
    path=“images/es/Buscar.gif”
    alternate=“Buscar” />
```

Since HTML uses a slash, /, instead of a backslash, \, as the separator character, Installer uses a slash as well when it updates the button's path.

Similarly, the XML files for the navigation elements store full path names to the files containing the legal notices. For Web-based search engines, Installer updates these full path names to paths that are relative to the directory where the GUI's HTML files will be installed. For other kinds of search engines, it updates these full path names to paths that are relative to the directory where the GUI's XML files will be installed. In our example, all of the gardening manual's GUI files will be installed in C:\Tomcat\webapps\GardeningManual, with the English files going in the en subdirectory and the Spanish files going in the es subdirectory. So Installer updates the legal notice file names within navigation elements to LegalNotice.html and AvisoLegal.html.

If needed, Installer updates the file names of the source document stored in the full text search page's XML files. These file names must include the source document installation directory specified with the eighth installation parameter, as described in Paragraph [00179], and must use HTML's file separator character. In our example, the source document is installed in C:\Tomcat\webapps\GardeningManual with the rest of the GUI installed in subdirectories named with ISO 639 language codes. Since the English files are in C:\Tomcat\webapps\GardeningManual\en, Installer updates the XML file containing the English version of the full text search page to use ../GeneralInfo.doc and ../PlantCatalog.doc as the relative path to the source document. It makes the same change in the Spanish version of the XML file, which is in C:\Tomcat\webapps\GardeningManual\es.

Similarly, it may need to change the path to the search engine servlet specified within the searchEngine servlet attribute of the navigation elements, advanced search, and preferences pages' XML files. Typically, the path to the servlet, including the character to use to separate elements of the path name, depends on the Web server. The gardening manual's search engine will be deployed on Apache Tomcat, which uses servlet path names of the form /servletName/servlet/servletName, where servletName is the servlet's name. So Installer updates the servlet's path to /GardeningManual/servlet/GardeningManual. Applications running on Apache Tomcat must be installed in a subdirectory under Tomcat's webapps subdirectory, and the servlet's name must be the same as the subdirectory's name. Since the user stated that the server's files should be installed in C:\Tomcat\webapps\GardeningManual\WEB-INF\lib, then Installer knows that the servlet's name must be GardeningManual.

The index page's XML files also have servlet invocations that Installer may need to update if the user wants a Web-based search engine. In our example, Installer changes the entry elements' servlet attribute to start with /GardeningManual/servlet/GardeningManual instead of with /SearchEngine.

Installer also copies Search Configuration to a temporary directory and changes the full path names to the source electronic document's files after storing their original value in one of Installer's internal data structures. Installer uses the original full path names to locate the source electronic document files when it needs to install them; the new full path names point to the installed version of the source document files. Within Search Configuration, it also updates the entry for the full path name to Column Headings; this now points to the copy of the file that will be installed on the target platform. It uses the target Web server's file separator character within these full path names.

Within the temporary copy of Search Configuration, Installer also changes the JDBC driver, relational database name, user name, user password, and table name with the corresponding values entered via Installer Configuration's tenth through fourteenth parameters, as noted in Paragraphs [00183] to [00187]. What it does next depends on the type of search engine that's desired, as captured by the parameter described in Paragraph [00169].

If the user wants a Web application, then Installer copies to the temporary directory the XML file corresponding to the GUI's navigation elements. Within this temporary file, Installer changes XML file names to their corresponding HTML file name. This has the same base file name but an html instead of xml extension; for example, AdvancedSearch.xml gets renamed to AdvancedSearch.html. Installer proceeds to use XSLT and the XSL files supplied with the parameter described in Paragraph [00173] to translate each GUI XML file, whether in the temporary or original directory, to an HTML file having the desired graphic design. If the user didn't supply any XSL files, shown as XSL Files & Helper Files in FIG. 6, Installer uses default XSL stylesheets to create the HTML files. The resulting HTML files are created in the directory given by the parameter described in Paragraph [00179], with all files for a natural language being put in a subdirectory whose name is the two-letter ISO 639 code for the language. Installer then copies any files referenced by the XSL, as noted in Paragraph [00177] and represented with XSL Files & Helper Files in FIG. 6, and the legal notices noted in Paragraph [00178] and shown as Legal Notices in FIG. 6, to the directories specified with the parameter noted in Paragraph [00179]; the files' extension is used to determine the destination directory, and the natural language in which the file is written is used to determine the appropriate subdirectory.

Note that the XML for the navigation elements, advanced search, and preferences pages specifies the servlet or main program invocation to use to carry out the feature, as well the action that the servlet or main program must perform when called from the indicated page. This information is stored in the XML files' searchEngine element. The default XSL that translates these XML files to HTML uses this element's servlet attribute value as the value of the HTML form's action attribute. Within the HTML form, it creates a hidden input field named actionID and sets its value to the value stored in searchEngine'S actionID attribute. The search engine servlet or main program uses the value of the actionID field to figure out what it must do. Therefore, user-supplied XSL files must do likewise when translating these searchEngine elements.

In a similar manner, the index page's XML files also store the required servlet or main program invocation in the servlet attribute of each entry element. The default XSL that translates these XML files to HTML uses the servlet attribute as the value of an HTML a href attribute. For example, the index entry for Amaryllis gets translated to <a href=“/GardeningManual/servlet/GardeningManual?actionID=primaryKeySearch&plantName=Amaryllis”>Amaryllis</a>. Therefore, user-supplied XSL files must do likewise when translating these entry elements.

Similarly, the default XSL that translates the help page's XML file to HTML uses the anchors defined in the toc and section elements to create HTML a links and anchors to the relevant part of the help file. For example, Paragraph [00160] shows the table of contents' anchors within the toc elements. For the preferences feature, the anchor's value is preferences in English and preferencias in Spanish. The XSL translates these XML toc elements to <a href=“#preferences”>Preferences</a> in English and <a href=“#preferencias”>Preferencias</a> in Spanish. The anchors within the corresponding section elements are shown in Paragraph [00161]. The XSL translates these elements to HTML <a name=“preferences”>Preferences</a> in English and <a name=preferencias”>Preferencias</a> in Spanish. Thus, when a user clicks the Preferences link within the English HTML help file's table of contents, the help file will be positioned at the start of the Preferences section containing instructions on using this feature. If a user defines his own XSL stylesheet for translating the help file's XML to HTML, he must ensure that the stylesheet translates the toc and section elements as illustrated above.

The default XSL that translates the XML file containing the advanced search page also creates a link to the section of the help file containing instructions for this feature. It translates the XML link element to <a href=“Help.html#advancedSearch”>Help</a> in English and <a href=“Ayuda.html#buscarAvanzada”>Ayuda</a> in Spanish. The XSL that translates the preferences page's XML does likewise, creating <a href=“Help.html#preferences”>Help</a> in English and <a href=“Ayuda.html#preferencias”>Ayuda</a> in Spanish. If the user modifies the default XSL stylesheets for these pages, he must preserve the same translation of the help link.

Installer copies the source electronic document, represented as Electronic Document in FIG. 6, to the directory specified with the parameter described in Paragraph [00179]. This installed version of the source document appears as I. Electronic Document within the Installed Files component of FIG. 6.

Installer uses the value of its second configuration parameter, described in Paragraph [00170], to locate the database. It copies the database, shown as Database in FIG. 6, to the directory specified with the parameter described in Paragraph [00181]. This installed version of the database appears as Installed Database within the Installed Files component of FIG. 6. It copies the Java libraries for searching, Search Libraries of FIG. 6, to the directories specified with the parameter described in Paragraph [00181]. The Java libraries for searching are the same for all generated search engines; they are part of Search Engine Generator. The libraries include the Java resource bundle that provides internationalization and localization of the search engine's search results and search error pages. Installer updates the copied resource bundle by adding a bundle for the search engine's name, which it copies from any of the GUI XML files. The search engine uses this bundle when creating the search results and search error pages.

Installer updates the temporary copy of Search Configuration to include the name of the search engine servlet that processes searches and sets search preferences, using the separator character that the target Web server expects within the path to the servlet. For the gardening manual search engine running on Apache Tomcat, GardeningManual and /GardeningManual/servlet/GardeningManual are the values it stores in Search Configuration. Installer also adds any other configuration or initialization parameters that the target Web server requires of applications running on it. For Apache Tomcat, this includes the search engine servlet's Java class name, including its Java package prefix; the search engine servlet is part of the search engine libraries. Installer then completes the installation process by using an XSLT with XSL to transform the modified Search Configuration to the target Web server's configuration or initialization file format. It creates the resulting file in the directory that the Web server specifies for such files, and copies Column Headings to the same directory. These installed versions of Search Configuration and Column Headings appear as I. Search Configuration and I. Column Headings within the Installed Files component of FIG. 6. Installer also checks that a document editor for the original source document is installed, and notifies the user if there is none.

For other kinds of search engines, Installer follows similar steps, so we only mention the differences here. Within the installed XML files containing the navigation elements, advanced search, and preferences, Installer changes the name of the XML help file to the corresponding file in the target platform's online help system format. Installer then uses XSLT with an internal XSL to transform the XML file containing the documentation into the target platform's online help system format; it creates this file in the same directory where the GUI's XML files are installed. However, it does not have to transform the other XML files containing the GUI. Instead, when the automatically generated search engine executes, it reads these XML files to determine which GUI controls have to be created, how they should be labeled, what values should appear in drop-down lists, what values should be the default, and so on. This is similar to using a Java ResourceBundle for providing internationalized and localized applications, but is a more general approach since it also handles an arbitrary number of controls of a variety of types.

Since the XML files may contain full or relative path names whose file separator character may not be the same as that used by the operating system on which the search engine is running, the search engine uses Java's System.getProperty(“file.separator”) to figure out what file separator it should use within path names. After retrieving a path name from an XML file, the search engine makes any necessary changes to the file separator character before using the path name to locate a resource, such as the image to use for the search button.

For non-Web versions of the search engine, Installer does not have to add a servlet name or Web server parameters to Search Configuration; it does not have to transform it to another format. In this case, Search Configuration and Column Headings are just installed in the directory specified with the parameter described in Paragraph [00181], which is the same directory where Search Libraries was installed.

For all kinds of search engines, Installer creates Administrator Configuration of FIG. 6. This is an XML file containing the parameters used to guide search engine maintenance tasks, as described in the Administrator section. As with all XML files, it also contains an element to store the version of the XML schema language used to create it. Installer creates the file in the location given by its fifteenth parameter, as noted in Paragraph [00188].

Once Search Engine Installer completes its task, it displays a message informing the user that the XML file containing the online help will probably need editing to include examples and other user-supplied information. The message includes the file's full path name, and a reminder to use the Administrator component to regenerate the online help after editing.

The end result is the component labeled Search Engine in FIG. 6, a search engine deployed on the target installation platform. Additional aspects of its design, and its use, are described in the following section.

### Search Engine

Search Engine Generator creates Search Engine of FIGS. 2, 6, and 7, a custom search engine for the electronic document that was supplied to it. This tailored approach allows the majority of users, i.e., those who are unfamiliar with the document's contents, to search it more efficiently.

FIG. 7 shows the overall structure of Search Engine, including its inputs and outputs. Search Engine takes as input the installed source electronic document, labeled I. Electronic Document in FIG. 7. Search Engine also needs the automatically generated database that was installed on the target platform; it's labeled Installed Database in FIG. 7. The parameters used to connect to the database are stored in the installed configuration file labeled I. Search Configuration in FIG. 7. Search Results of FIG. 7 is the only output from Search Engine; the results may be an error message if something went wrong during the search. Search Engine can also launch a document editor, labeled Document Editor in FIG. 7, so the user can read or search through the source electronic document. The installed version of Column Headings, labeled I. Column Headings in FIG. 7, is used to format search results, as explained below.

For search engines generated to run on the Web, the graphical user interface's graphic design is customized as specified with the XSL that the user supplied via Installer Configuration, as described in Paragraphs [00173] to [00176]. For other kinds of search engines, the graphical user interface has the native look and feel of the platform on which it will run.

Search Engine's graphical user interface is internationalized and localized. Its buttons, links, and text appear in the natural language specified by its user's preferences, or in the natural language chosen by Search Engine Generator's user when he created Search Engine. The only exception is the data retrieved from the database. This will be available in the same natural language of the GUI only if the source electronic document is written in that language.

FIG. 24 shows the home page of the automatically generated search engine for the gardening manual that we have been using as an example. The search engine's name appears in the upper left, while the navigation elements are in the upper right. These include search by primary key, a button to start the search, and links to advanced search, full text search, index, preferences, help, and home pages. The copyright notice and link to the legal notice are at the bottom of the window. These elements appear in the same location on all the gardening manual's pages, as shown in FIGS. 24-27, 29-34, and 36. These screen shots also illustrate that, except for the home page, each page of the sample Web-based search engine for the gardening manual also has a title describing the page's contents. For example, Advanced Search is the title of the page shown in FIG. 25.

The search engine's features fall into four main categories: search, reports, preferences, and documentation. We describe each in turn.

### Search Features

Search Engine allows the user to search by the primary key that was initially specified via Extractor Configuration. In the graphical user interface, he types values into the primary key fields, where there is one field per column in the primary key. Since our gardening manual example has only one field in the primary key—the plant name—there is only one text field next to the Search button in FIGS. 24-27, 29-34, and 36. Any records whose primary key contains the values entered here are included in the search results. The user may also search for records whose primary key exactly matches, regardless of case sensitivity, the values he enters.

The user interface for the advanced search feature is shown in FIG. 25. The Search For column contains an entry for each column in the database; the entries are labeled with the column headings specified via Column Headings. For each entry, there are corresponding input fields in the rest of the row. For columns whose values are limited to a few distinct values, the possible values appear in a drop-down list to facilitate selection. In our gardening manual example of FIG. 25, all the fields except the plant name have a drop-down list.

Users may enter a value into any field, or combination of fields. If he does so in the column labeled All in FIG. 25, all records whose columns contain the values specified in the fields will be returned once the user clicks the form's Search button; this corresponds to a logical AND operation. In FIG. 25, we're searching for plants with white flowers that bloom in the spring. Logical OR operations are also allowed by entering values into the corresponding section of the search form, that is, into the column labeled Any in FIG. 25; it has the same controls as the section for logical AND operations. Similarly, the None column in FIG. 25 is for specifying logical NOT operations, and the Exact Match column is for specifying exact matches. By entering values into one or more of these columns, the user may specify even more complex Boolean expressions involving AND, OR, NOT, and exact matches. While this approach does not allow an arbitrary Boolean expression to be entered, it covers the majority of the useful cases while providing an intuitive interface for non-programmers. The matches are always case insensitive. The Help link of FIG. 25 displays instructions for using the advanced search feature.

Search Engine also provides an index containing the values of each primary key. This allows browsing all the entries in the database, and simplifies navigation to a given record. The index page for the gardening manual's search engine is shown in FIG. 26. The letter links at the top of the page are used to navigate to the section of the page containing the records beginning with the selected letter. Clicking on a plant's name displays a page containing the care instructions for the selected plant. This page is formatted as for a search result, which is described below.

Search Engine also provides access to the source electronic document by launching an application that can be used to read it. This application will typically be a word processor providing a Find feature, which is useful for searching the unstructured parts of the document.

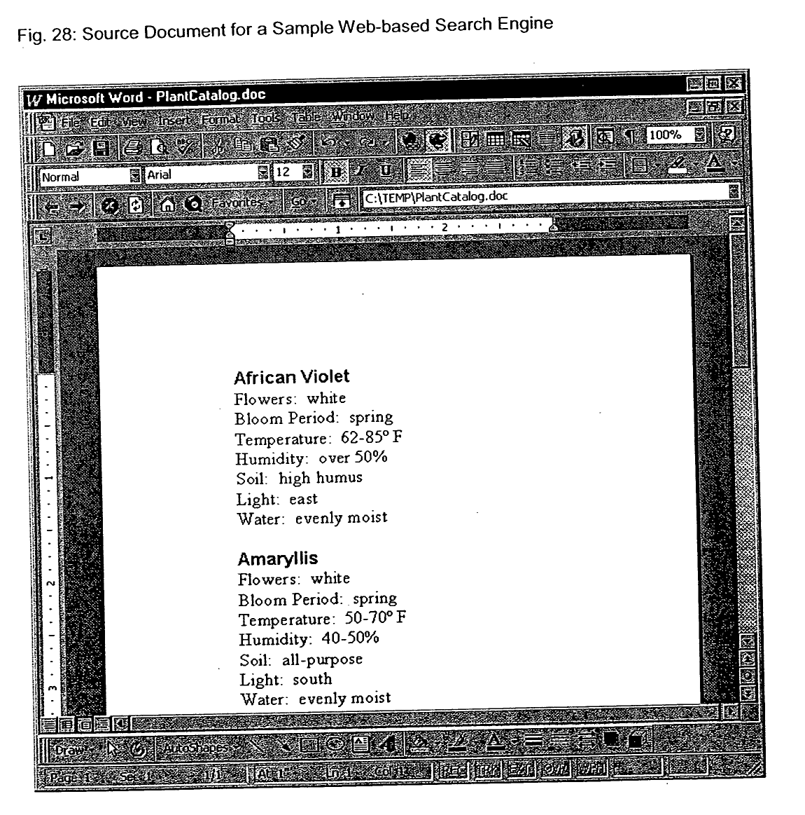

FIG. 27 shows the gardening manual search engine's page for performing full text searches. Since the source document is in two parts, as noted in Paragraph [0065], the page contains a link to each part of the document, as noted in Paragraph [00136]. The descriptions are those provided via Search Configuration, as noted in Paragraph [00165]. Clicking one of these descriptions launches the application used to read that section of the source document. FIG. 28 shows the result of clicking the Plant Catalog link, which launched Microsoft Word to edit a copy of the plant catalog.

For search engines installed on the Web, there's also a link to quickly navigate to the engine's home page. This is the Home link of FIGS. 24-27, 29-34, and 36; clicking it displays the page shown in FIG. 24. For other platforms, Search Engine has a menu item to navigate to its main window.

In Web-based versions of Search Engine, searching by column or columns is implemented as forms that call a servlet written in Java. For other versions of Search Engine, a main program contains a command for searching by column or columns; this displays a form similar to that of the Web-based version of Search Engine. In either case, the column headings specified with Column Headings, as noted in Paragraph [00140], are used as labels for the text input fields in the form.

When the user issues the search command, the servlet receives the form data. In non-Web Search Engine versions, the main program retrieves the user's input from the search form. Both the servlet and main program use a common library of classes to connect to the relational database using the JDBC driver, database server, user, and password specified with Search Configuration. The Search Engine server code also contains classes for database connection pooling, connecting to the table created with Database Generator (its name is stored in Search Configuration), creating and executing a SQL select query containing the column values the user entered in the search form, formatting the search results, and logging errors; these Java classes are implemented with standard techniques. The search results are formatted in XML and the XSL specified with Installer Configuration, as noted in Paragraphs [00173] to [00176], is used with XSLT to translate the XML to HTML. In non-Web versions of the search engine, the search results are automatically generated in a format that can be displayed in the native platform's graphical user interface.

Search Engine expresses the results of a search as an XML file. If the Search Engine allows changing the natural language used within the GUI, as determined by the presence of this feature within the preferences page, then it creates one such XML file for each natural language in which the GUI can be displayed. As with all the XML schema languages used to define the GUI's pages, this schema language defines an element that models the page, including the version of the schema language used to create the file: <page xmlSchemaVersion=“1.0” name=“searchResults” title=“Search Results”>. This examples shows that the file was created with the first version of the XML schema language, the page's name for use within source code is searchResults, and its title for use in the English GUI is Search Results; the Spanish GUI would have a similar element, but its title would be Resultados de la Búsqueda. It also has an element for the search engine, including its title; the English GUI uses <searchEngine title=“Gardening Manual”/> while the Spanish GUI has <searchEngine title=“Manual de Jardineria”/>. Search Engine gets these titles from a standard Java resource bundle that is part of the search libraries that Search Engine Installer installed.

The XML schema language for the search results page also defines elements to store (1) the search criteria, expressed as a Boolean expression involving column headings and value pairs; the column headings appear in the natural language used elsewhere in the GUI; (2) the sort criteria using column headings in the natural language used elsewhere in the GUI; (3) the range of matching records being displayed, and the total number of matching records; (4) links to the prior and next pages, as well as to all pages between these, if all search results don't fit on one page; each link element stores the search engine servlet or main program invocation to generate the desired page of results, with the path to the servlet coming from Search Configuration; (5) a list of column headings, expressed in the natural language used elsewhere in the GUI; each element in the list also stores the search engine servlet or main program invocation to sort the results by that column; and (6) a list of matching records, where each record consists of the value for each column the user chose to have in the results, as given by his preferences. Search Engine gets the column headings from Column Headings, which appears in FIG. 7 as I. Column Headings.

Within the search results, Search Engine formats numbers, currencies, percents, dates, times, timestamps, and Boolean values as indicated by Column Headings.

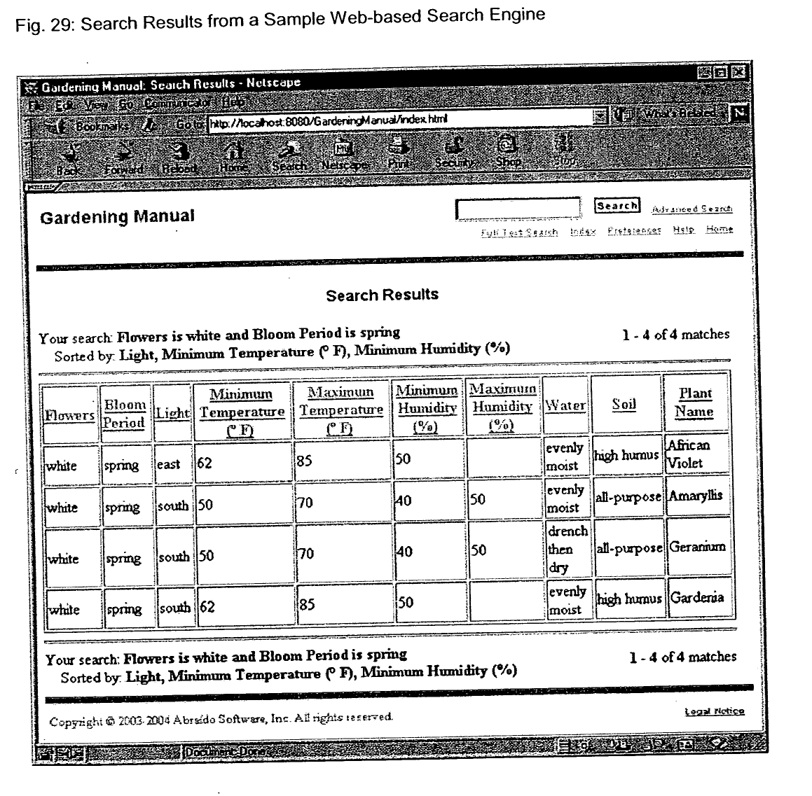

FIG. 29 shows the page containing the results for the search of FIG. 25, using the preferences noted in FIGS. 31-32. Clicking a column heading sorts the results by that column's values.

Search Engine expresses search errors as an XML file. If the Search Engine allows changing the natural language used within the GUI, as determined by the presence of this feature within the preferences page, then it creates one such XML file for each natural language in which the GUI can be displayed. As with all the XML schema languages used to define the GUI's pages, this schema language defines an element that models the page, including the version of the schema language used to create the file: <page xmlSchemaVersion=“1.0” name=“searchError” title=“Search Error”>. This examples shows that the file was created with the first version of the XML schema language, the page's name for use within source code is searchError, and its title for use in the English GUI is Search Error; the Spanish GUI would have a similar element, but its title would be Error en la Búsqueda. It also has an element for the search engine, including its title; the English GUI uses <searchEngine title=“Gardening Manual”/> while the Spanish GUI has <searchEngine title=“Manual de Jardineria”/>. Search Engine gets these titles from a standard Java resource bundle that is part of the search libraries that Search Engine Installer installed.

The XML schema language used for the error pages also defines an element to store the actual error message. It includes subelements to specify (1) the search criteria, expressed as a Boolean expression involving column headings and value pairs; the column headings appear in the natural language used elsewhere in the GUI; (2) the sort criteria using column headings in the natural language used elsewhere in the GUI; (3) the SQL code corresponding to the search and sort criteria; and (4) the error message, expressed in the natural language used elsewhere in the GUI. Search Engine gets the column headings from Column Headings, which appears in FIG. 7 as I. Column Headings. It gets the error message's text from its standard Java resource bundle in the search engine libraries. Note that part of the error message's text may also come from the search engine's Java runtime environment; this portion will be expressed in the natural language used within the Java runtime environment.

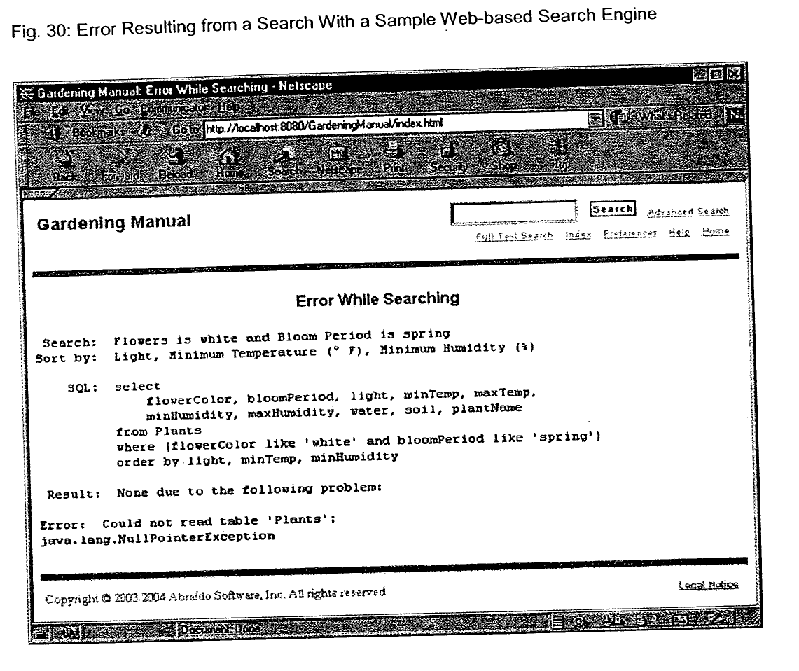

If any error is encountered while searching the database or creating the report, the error message is formatted in XML and the XSL specified with Installer Configuration, as noted in Paragraphs [00173] to [00176], is used with XSLT to translate the XML to HTML. FIG. 30 shows a page displaying an error that occurred while executing the search shown in FIG. 25 with the preferences of FIGS. 31-32. In this example, the search engine could not read the Plants database table. This can happen, for example, if the database administrator has temporarily made the database unavailable. In non-Web versions of the search engine, the error message is automatically generated in a format that can be displayed in the native platform's graphical user interface.

### Reports

Search Engine displays the results of a search in a table having one column for each column in the database, or as given by the user's preferences. The column headings are those specified via Column Headings, in the natural language specified by the user's preferences, or in the natural language that Search Engine Generator's user chose when creating Search Engine. The results in FIG. 29 have the columns corresponding to the user's preferences as given by FIGS. 31-32.

The report also includes the total number of matching records, and the range of records that are currently displayed. This appears in FIG. 29 as 1-4 of 4 matches. It provides a way to navigate to the previous or next subset of matching records, as well as to any subset of matching records within the set. Since all of our example's search results can be put in one table, according to the user's preferences of FIGS. 31-32, then the search results page in FIG. 29 does not have Next, Previous, or page number links.

The user may sort the results by any column by clicking the column's name. The user may also specify which columns should appear in the search results, and how many results should appear per page, via the preferences feature.

Navigation to a different subset of matching records may be implemented in two basic ways, both of which use standard techniques. For very large data sets, the query may be rerun, and only the desired group of records can be retrieved from the database and copied into Search Engine's data structures for display in the report. Alternatively, small data sets can be kept in memory at all times so that the desired subset can be displayed quickly.

The same basic techniques apply to sorting by different columns. To sort very large data sets, we can rerun the query with a SQL order by clause containing the selected column's name. Smaller data sets that are always kept in memory may be sorted with any standard, efficient sorting technique.

Similarly, to regenerate the report with a different selection of columns we may either rerun the query or reformat data that is already in memory. When rerunning the query, the SQL select statement is executed with a list of the desired columns' names instead of with the wildcard character that selects all columns. For example, all columns are selected by default, so if searchCriteria contain the search criteria and sortCriteria contains the sort criteria, then the SQL select query would be: select * from Plants where searchCriteria order by sortCriteria. However, if the user changes his preferences so that only the plant name and flower color appear in the search results, then the SQL select query would be select plantName, flowerColor from Plants where searchCriteria order by sortCriteria.

### Preferences

With the preferences feature, the user may specify several defaults that control Search Engine's behavior. For example, he can decide if the preferences should be applied to all reports, or just the current one. He can choose the natural language to use within the GUI, if the Search Engine Generator user made this feature available. He can also decide if the results should appear in the current window, or in a new one.

The user may also choose how many results should be displayed per page, which columns should be used by default to order the results, and which columns should be included by default in the table displaying the results.

FIGS. 31-32 show the preferences page for our Web-based gardening manual search engine. In this example, the preferences are being applied to all reports, English is being used as the natural language within the GUI, search results appear in the current window instead of in a new one, and there are at most ten results per page. The results are sorted by light values. If two or more results have the same light value, they're sorted by minimum Fahrenheit temperature. For results that have the same light and minimum Fahrenheit temperature, the minimum humidity is used for sorting. These sort criteria were selected by clicking them in the Columns Available for Sorting list, and then clicking the Sort By link. Note that the sort criteria are transferred from the left to the right box. To remove a sort criteria, the user would select it in the rightmost box, and click the Undo link. The selected item would be moved from the right to the left box.

The GUI for selecting columns to include in the report is similar, but it has an Include link instead of a Sort By link. In FIG. 32, all columns appear in the search results except for the temperature in degrees Celsius.

The Apply button of FIG. 32 actually applies the preferences throughout the search engine, while the Reset button restores the form's fields to the current value of the preferences. The Help link displays instructions for changing the preferences.

For Web-based versions, Search Engine uses standard session tracking to associate preferences with users. In this case, the initial preferences are stored in the preferences page's HTML code that Search Engine Installer created. For other versions, Search Engine maintains the user's preferences in memory. In this case, the initial preferences are stored in the XML file that GUI Generator created for the preferences page.

### Documentation

Search Engine's documentation includes online help describing the various features and how they work. The help file is written in the natural language used throughout the rest of the GUI, with translations in other natural languages if the search engine's GUI allows changing the language in use. FIG. 33 shows part of the help file containing instructions for the preferences feature. The help files are automatically created in XML using information from GUI Configuration, GUI Generator's configuration parameters.

Installer uses XSLT with the XSL specified with Installer Configuration, as noted in Paragraphs [00173] to [00176], to transform these XML help files to HTML. For non-Web versions of the search engine, Installer automatically translates the help files to the native platform's online help system format.

Typically, these automatically generated help files will need editing to include examples and explanations that cannot be deduced from the configuration parameters. Special XML elements within the XML version of the help file denote this user-supplied text, so that it will not be lost if the search engine is regenerated with different configuration parameters. Any XML or text editor can be used to enter user-supplied text within the help file's XML, and then the Administrator component can be used to regenerate the help file for the target platform.

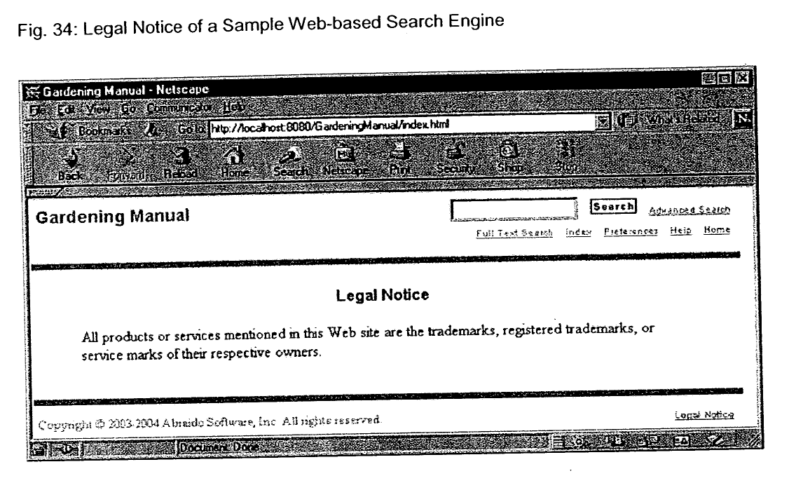

The Search Engine's documentation also includes a legal notice. This notice is available in the natural language used throughout the rest of the GUI, with translations in other natural languages if the search engine's GUI allows changing the language in use. The user must provide the legal notice in the target platform's required format. For search engines running on the Web, this will typically be HTML, but it can be any word-processed format for which the word processor is installed. For other kinds of search engines, it must be in the target platform's online help system format. FIG. 34 shows the legal notice for the gardening manual's search engine. It is meant as an example, and does not necessarily cover all the legal issues that are addressed in the search engine's actual legal notice.

### Administrator

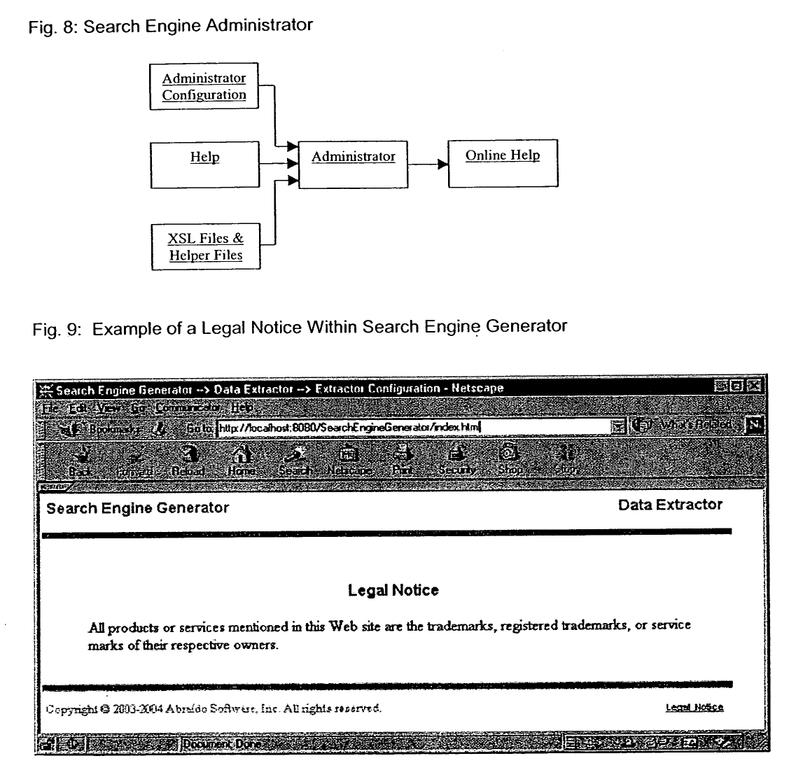

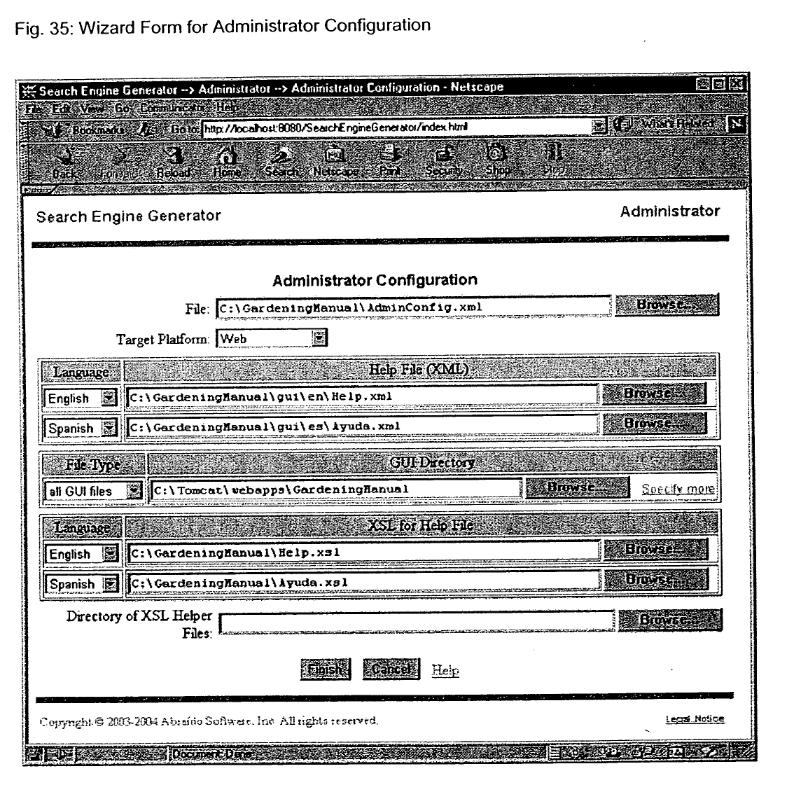

FIG. 8 shows the inputs to, and outputs from, the Administrator component. It is used for Search Engine maintenance tasks, such as regenerating the online help when the user updates it with examples. As is the case with Search Engine Generator, Administrator provides a standard wizard to guide the user in changing values for the parameters that control the search engine maintenance process. This wizard is shown in FIG. 35. It contains a title, copyright notice, and link to a legal notice, as described in Paragraph [0022]. It also contains Finish and Cancel buttons that are similar to those described in Paragraph [0023]. The Finish button regenerates the search engine's online help, and the Cancel button exits without changing the help file. The link to online help displays the instructions for filling out the form, as described in Paragraph [0023]. The form's File text field and Browse button are used to select an existing file containing Administrator configuration parameters; these controls work as described in Paragraph [0024]. Typically, the user will select the Administrator configuration file that Search Engine Installer created, as noted in Paragraph [00209]. The remaining items in the form are used to specify Administrator's configuration parameters. These configuration parameters are stored in FIG. 8's Administrator Configuration, which is an XML file created with Installer of FIG. 6. There are five configuration parameters, and they're described below.

The first parameter, Target Platform of FIG. 35, is the type of system on which to regenerate the online help; it can either be the Web, a network of computers, a standalone computer, or a PDA, though a similar approach could be used for other platforms. It should be the same value supplied via Search Engine Installer's first configuration parameter, as described in Paragraph [00169]. In fact, Search Engine Installer stores this value for the first parameter when it creates Administrator Configuration.

The second parameter is the full path name of the XML file containing the online help. It's in the table with Language and Help File (XML) headings in FIG. 35, since the file's location depends on the natural language used for the file's contents. For search engines that were generated in several natural languages, such as our gardening manual, there will be one help file per language. Each row's Browse button can be used to select the file with a standard file chooser such as that in FIG. 11. It should be the same file that GUI Generator created in the indicated natural language, as described in Paragraph [00159]; these help files are represented as Help in FIG. 8. For convenience, Search Engine Installer stores their file names in the second parameter when it creates Administrator Configuration. The user can avoid regenerating help in a given language by deleting its file name from this table. He can add examples and other documentation by editing the help file with any XML or text editor. To illustrate, let's add the source document's author, title, and publication information to the help file's Introduction section.

```
<!-- In the XML file containing the English GUI -->
<section
    name=“introduction”
    title=“Introduction”
    anchor=“intro”>
    <para>This Web site allows you to search for information
contained in
        <user_srcDoc
            author=“Leonor M. Abraído-Fandiño”
            title=“Gardening Manual”
            publisher=“Abraído Software, Inc.”
            publicationDate=“2004” />
    </para>
</section>
<!-- In the XML file containing the Spanish GUI -->
<section
    name=“introduction”
    title=“Introducción”
    anchor=“intro” />
    <para>Este sitio Web le permite buscar información contenido en
        <user_srcDoc
            author=“Leonor M. Abraído-Fandiño”
            title=“Gardening Manual”
            publisher=“Abraído Software, Inc.”
            publicationDate=“2004” />
    </para>
</section>
```

The third parameter stores the full path name of the directories in which the search engine's GUI files are installed; this parameter's user interface is shown in the first table in FIG. 35. This parameter's value should be the same one entered for Installer Configuration's eighth parameter, as noted in Paragraph [00179], which also describes how the table's controls work in FIG. 35. Search Engine Installer creates Administrator Configuration with the proper value.

The fourth parameter is the full path name of the XSL file or files used to translate the help file's XML to HTML, if a Web version of the search engine must be updated. This should be the same value entered for Installer Configuration's fifth parameter, as noted in Paragraphs [00173]-[00176]; for convenience, Search Engine Installer copies this value to Administrator Configuration when it creates the file. The fourth parameter's user interface is the second table in FIG. 35, and it operates in the same manner as the corresponding table in Installer Configuration's user interface; see Paragraphs [00174]-[00176] for details. The only difference is that there are no Specify more links since Installer already populates the table with one row per natural language in which the GUI was generated. The fourth parameter is represented in FIG. 8 with XSL Files & Helper Files.

The fifth parameter is the full path name to the directory containing the files referred to by the XSL file, if any. It's the Directory of XSL Helper Files field in FIG. 35, whose Browse button displays a file chooser similar to that in FIG. 11. This parameter's value should be the same as Installer Configuration's sixth parameter, as noted in Paragraph [00177], and in fact, Search Engine Installer creates Administrator Configuration with this value. The fifth parameter is also represented with XSL Files & Helper Files in FIG. 8.

The main administration component, labeled Administrator in FIG. 8, gets one input parameter. This parameter is the object representing the information in the configuration file, Administrator Configuration, created with Search Engine Installer and possibly edited with Administrator's wizard.

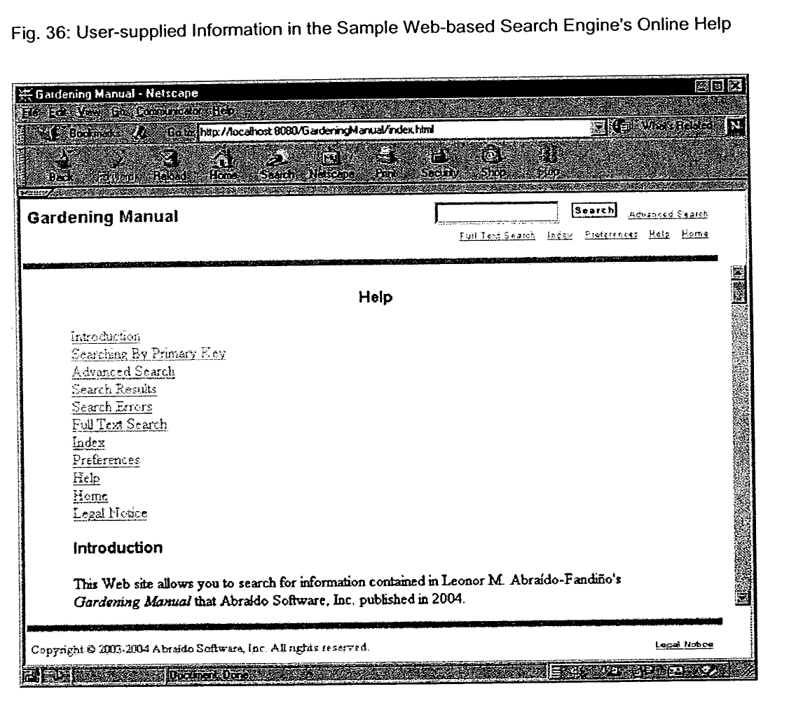

Administrator's actions depend on the type of platform for which the online help files must be recreated, as given by Paragraph [00251]. If it's for a Web-based search engine, Administrator transforms the help files' XML (Paragraph [00252]) to HTML using XSLT with the XSL noted in Paragraph [00254], or a default XSL if the user didn't supply one. It creates the HTML files in the directory referred to in Paragraph [00253], but places each language's file in a subdirectory named with the corresponding ISO 639 language code. It then copies the files referred to by the user's XSL, if any, to the directory given by Paragraph [00253]; the files' extension is used to determine the destination directory. FIG. 36 shows the English help file's Introduction section after we've regenerated it with the source document's author, title, and publication information. This screen shot also shows the help file's title and table of contents.

If the user wants to regenerate the online help for a platform other than the Web, then Administrator uses XSLT with a default XSL to transform the help files' XML to the target platform's online help system format. The files are created in the directory referred to by Paragraph [00253], but places each language's file in a subdirectory named with the corresponding ISO 639 language code.

The end result is Online Help of FIG. 8, a help file in the help system format of the platform on which the search engine is running.

It should be noted that although the invention has been described with respect to a computer executing a program to read a document, then extracting the structured data therefrom, and creating a database, the invention can also be practiced to cover documents that have already been scanned or read.

What is claimed is:

1. A method of generating a searchable database from a document, having structured data, comprising:
reading the document by a computer;
extracting the structured data by the computer; and
creating a database with the extracted structured data by the computer.

2. The method of claim 1 further comprising:
generating a search engine for searching said database by the computer;
wherein said search engine is capable of searching the document.

3. The method of claim 2 wherein said step of extracting the structured data further comprises:
specifying the format of the structured data by a user;
specifying the parameters by the user wherein the parameters control the data extraction by the computer;
parsing the document by the computer;
creating a database structure by the computer; and
extracting the structured data.

4. The method of claim 3 wherein the step of creating a database further comprises:
inputting database structure to a database generator based upon the database structure created;
inputting a database configuration based upon a user input;
inputting data based upon the data extracted; and
generating the database by the computer.

5. The method of claim 2 further comprising:
generating a graphical user interface after creating the database by the computer.

6. The method of claim 5 further comprising:
installing the search engine created by a self-executing program on the computer.

7. An article of manufacture comprising:
a computer-usable medium having computer readable program code embodied therein configured to generate a searchable database from a document having structured data, wherein said computer readable program code in said article of manufacture comprising:
computer readable program code configured to cause the computer to extract the structured data; and
computer readable program code configured to cause the computer to create a database with the extracted structured data.

8. The article of manufacture of claim 7 further comprising:
computer readable program code configured to cause a computer to read the document;

9. The article of manufacture of claim 8 further comprising:
computer readable program code configured to cause a computer to generate a search engine for searching said database;
wherein said search engine is capable of searching the document.

10. The article of manufacture of claim 9 wherein said computer readable program code configured to cause a computer to extract the structured data further comprises:
computer readable program code configured to cause a computer to receive the format of the structured data specified by a user;
computer readable program code configured to cause a computer to receive the parameters specified by the user wherein the parameters control the data extraction by the computer;
computer readable program code configured to cause a computer to parse the document;
computer readable program code configured to cause a computer to create a database structure; and
computer readable program code configured to cause a computer to extract the structured data.

11. The article of manufacture of claim 10 wherein the computer readable program code configured to cause a computer to create a database further comprises:
computer readable program code configured to cause a computer to receive input database structure to a database generator based upon the database structure created;
computer readable program code configured to cause a computer to receive user input of a database configuration;
computer readable program code configured to cause a computer to input data based upon the data extracted; and
computer readable program code configured to cause a computer to generate the database.

12. The article of manufacture of claim 9 further comprising:
computer readable program code configured to cause a computer to generate a graphical user interface after creating the database.

13. The article of manufacture of claim 12, further comprising:
computer readable program code configured to cause a computer to install the search engine created by a self-executing program.

14. The article of manufacture of claim 12 wherein said computer readable program code configured to cause a computer to generate a graphical user interface is internationalized and localized.

15. The article of manufacture of claim 7 wherein said computer readable program code in said article of manufacture is executable within a browser operating in the World Wide Web.

16. A computer having a computer readable program code for generating a searchable database from a document having structured data, wherein said computer comprises:
a computer for executing the computer readable program code, wherein said computer readable program code comprises:
computer readable program code for reading the document by the computer;
computer readable program code for extracting the structured data by the computer; and
computer readable program code for creating a database with the extracted structured data by the computer.

17. The computer of claim 16 wherein the computer readable program code for generating a searchable database further comprising:
computer readable program code for generating a search engine for searching said database by the computer;
wherein said search engine is capable of searching the document.

18. The computer of claim 17 wherein the computer readable program code for extracting the structured data further comprises:
computer readable program code for receiving user input to specify the format of the structured data;
computer readable program code for receiving user input specifying the parameters that control the data extraction by the computer;
computer readable program code for parsing the document by the computer;
computer readable program code for creating a database structure by the computer; and
computer readable program code for extracting the structured data.

19. The computer of claim 18 wherein the computer readable program code for creating a database further comprises:
computer readable program code for inputting database structure to a database generator based upon the database structure created;
computer readable program code for receiving user input of a database configuration;
computer readable program code for inputting data based upon the data extracted; and
computer readable program code for generating the database by the computer.

20. The computer of claim 17 wherein the computer readable program code further comprising:
computer readable program code for generating a graphical user interface after creating the database by the computer.

21. The computer of claim 20, wherein the computer readable program code further comprising:
computer readable program code for installing the search engine created by a self-executing program on the computer.
